(19) United States
(12) Patent Application Publication
(10) Pub. No.: US 2023/0063404 A1
(43) Pub. Date: Mar. 2, 2023

(54) Data Fusion System Combining Drone Footage, Social Media, and Other Elements

(71) Applicant: Chenope, Inc., Half Moon Bay, CA (US)

(72) Inventors: Elizabeth CHARNOCK, Half Moon Bay, CA (US); Steven L. ROBERTS, Half Moon Bay, CA (US); Nataliia Sytnyk, Kamianets-Podilskyi (UA)

(21) Appl. No.: 17/901,850

(22) Filed: Sep. 1, 2022

Related U.S. Application Data
(60) Provisional application No. 63/239,784, filed on Sep. 1, 2021.

(51) Int. Cl. G06Q 50/00

(52) U.S. Cl. CPC G06Q 50/01; H04L 67/535

(57) ABSTRACT

Embodiments described herein involve a novel sensor system configured to provide sensor data and respond to events from an event feed that can be facilitated by other devices and/or a social media feed. Such enmbodiments can involve a sensor system having one or more sensors, and involve systems and methods including monitoring an area with the one or more sensors to obtain first sensor data; and for processing a sensor event to provide second sensor data outside a functionality of the one or more sensors: identifying another sensor system monitoring the area having the functionality to provide the requested second sensor data, the another sensor system monitoring the area comprising one or more another sensors; transmitting instructions to the another sensor system to provide the requested second sensor data; and responding to the sensor event with the requested second sensor data received from the another sensor system.

### BACKGROUND

### Cross Reference to Related Applications

This patent application is based on and claims the benefit of priority from provisional U.S. Pat. Application No. 63/239,784, filed on Sep. 1, 2021, the disclosure of which is hereby incorporated by reference herein in its entirety for all purposes.

### FIELD OF THE INVENTION

The present invention relates to a sensor fusion system that includes a heterogeneous peer-to-peer system in which one sensor can temporarily “recruit” other sensors when it detects an anomaly of significance so that other sensors in the area may reorient, move, change modes, turn on, or otherwise make adjustments so as to better record and analyze the anomaly for its duration in the space observable by that sensor. The invention also includes a subsystem with natural language-enabled chatbots that can both solicit and collect information from “human” sensors in a highly scalable, efficient and accurate way. The chatbots are backed by a dialog system that updates continuously based on newly-acquired human sensor data as well as other data collection systems, including those that belong to law enforcement, volunteer associations, or the military.

### BACKGROUND

Three significant technology-based changes to society in recent decades are creating an environment in which large numbers of de facto sensors can be activated when a noteworthy event has occurred and should be observed. These changes are:
1) Ubiquitous smart phones with cameras and full Internet capabilities; few people now leave home without them. Each human with a smart phone is in essence a sensor.
2) A wide and growing range of messaging applications, forums, and social media on the Internet, collectively ubiquitous. These provide the means of the human sensors for communicating their data.
3) The increasingly-commonplace presence of drones. Each drone carries at least one sensor.

This is not the dystopian world of constant surveillance but rather the possibility when — and only when — there is specific motivation, of very quickly enabling large numbers of recording devices and of commentators, data from which can be made available almost immediately and gathered.

In tandem with these changes, the world is clearly becoming a more dangerous place. Anomalous events of interest include but are not limited to drone and missile strikes, bombings of various kinds, shootings, gang robberies, riots, and hostile reconnaissance drones in one’s airspace, just to name a few. In addition, of course there are also natural disasters such as floods, forest fires, earthquakes, and the like. Yet, apart from such security and traffic cameras as may be present, in most places in fact there is little fixed surveillance. Nor is surveillance necessary or desirable — apart from the situation in which something unusual is occurring. However, when something unusual does occur — and most often, unusual is bad — being able to mobilize as many sensors of different kinds in the area in which the unusual thing occurred can be critical in saving lives and preventing avoidable destruction.

Mobilizing what we will refer to throughout this document as “human sensors” is much more complicated than flipping a switch to reorient a traditional sensor. Obtaining accurate information from human sensors of wildly varying degrees of quality is a difficult task under the very best of circumstances. Doing so under highly stressful and chaotic circumstances that will generally be present in the scenarios discussed in this application is substantially more difficult still. This is why the use of sophisticated anthropomorphic avatars and dialog systems optimized for dealing with communication under stressful circumstances is preferred to help overcome these challenges.

### SUMMARY

Aspects of the present disclosure can involve a method for a sensor system comprising one or more sensors, the method including monitoring an area with the one or more sensors to obtain first sensor data; and for processing a sensor event to provide second sensor data outside a functionality of the one or more sensors: identifying another sensor system monitoring the area having the functionality to provide the requested second sensor data, the another sensor system monitoring the area comprising one or more another sensors; transmitting instructions to the another sensor system to provide the requested second sensor data; and responding to the sensor event with the requested second sensor data received from the another sensor system.

Aspects of the present disclosure can involve a computer program for a sensor system comprising one or more sensors, the computer program including instructions involving monitoring an area with the one or more sensors to obtain first sensor data; and for processing a sensor event to provide second sensor data outside a functionality of the one or more sensors: identifying another sensor system monitoring the area having the functionality to provide the requested second sensor data, the another sensor system monitoring the area comprising one or more another sensors; transmitting instructions to the another sensor system to provide the requested second sensor data; and responding to the sensor event with the requested second sensor data received from the another sensor system. The computer program and instructions may be stored on a non-transitory computer readable medium and executed by one or more processors.

Aspects of the present disclosure can involve a sensor system comprising one or more sensors, the system including means for monitoring an area with the one or more sensors to obtain first sensor data; and for processing a sensor event to provide second sensor data outside a functionality of the one or more sensors: means for identifying another sensor system monitoring the area having the functionality to provide the requested second sensor data, the another sensor system monitoring the area comprising one or more another sensors; transmitting instructions to the another sensor system to provide the requested second sensor data; and means for responding to the sensor event with the requested second sensor data received from the another sensor system.

Aspects of the present disclosure can involve a sensor system involving one or more sensors, and a processor configured to execute instructions involving monitoring an area with the one or more sensors to obtain first sensor data; and for processing a sensor event to provide second sensor data outside a functionality of the one or more sensors: identifying another sensor system monitoring the area having the functionality to provide the requested second sensor data, the another sensor system monitoring the area comprising one or more another sensors; transmitting instructions to the another sensor system to provide the requested second sensor data; and responding to the sensor event with the requested second sensor data received from the another sensor system.

### BRIEF DESCRIPTION OF DRAWINGS

FIG. 1 is a diagram which illustrates an example of the types of sensors that would be likely to exist in an urban setting.

FIG. 2 is a diagram which illustrates communication among sensors.

FIG. 3 is a diagram which illustrates the example of a sensor recruitment request event.

FIG. 4 is a diagram which illustrates different event types.

FIG. 5 is a diagram which illustrates the high-level system architecture.

FIG. 6 is a diagram which illustrates the different types of paths.

FIG. 7 is a diagram which illustrates an example of a circuit.

FIG. 8 is a diagram which illustrates an example of a trajectory.

FIG. 9 is a diagram which illustrates an example of a pattern of life path.

FIG. 10 is a diagram which illustrates the determination of the earliest point of arrival of different actors of interest.

FIG. 11 is a diagram which illustrates the concept of slots.

FIG. 12 is a diagram which illustrates the slot filling process at different times t.

FIG. 13 is a diagram which illustrates the slot filling logic.

FIG. 14 is a diagram which illustrates options in case of conflicting sensor data.

FIG. 15 is a diagram which illustrates an example of object-type specific slots.

FIG. 16 is a diagram which illustrates different clusters as itemsets.

FIG. 17 is a diagram which illustrates different kinds of readers in social media feeds.

FIG. 18 is a diagram which illustrates binding of location data in the sensor fusion engine.

FIG. 19 is a diagram which illustrates disqualifying data based on invalid timestamps.

FIG. 20 is a diagram which illustrates a user initiating a new mascot app session.

FIG. 21 is a diagram which illustrates different components for a dialog system.

FIG. 22 is a diagram which illustrates dynamic modification of a user position in the dialog tree.

FIG. 23 is a diagram which illustrates dynamic modification of a dialog tree.

FIG. 24 is a diagram which illustrates how previously provided data may be invalidated based on newly provided information.

FIG. 25 is a diagram which illustrates the dialog state preservation.

FIG. 26 is a diagram which illustrates an example of a deception branch.

FIG. 26A is a diagram which illustrates the training ML component using system features.

FIG. 27 is a diagram which illustrates the avatar media selection.

FIG. 28 is a diagram which illustrates an example of failover after > N attempts at a turn.

FIG. 29 is a diagram which illustrates an example of a chatbot avatar reacting to an update.

FIG. 30 is a diagram which illustrates the different sections of a dialog session.

FIG. 31 is a diagram which illustrates an example of multivariate / ML model of user information solicitation optimality.

FIG. 32 is a diagram which illustrates an example of user sophistication level.

FIG. 33 illustrates an example computing environment with an example computer device suitable for use in some example implementations, such as a server, drone, controller, or other device described herein.

### DETAILED DESCRIPTION

As both the density and kind of sensors [100] with which to observe reality multiply, sensor fusion systems [10] seeking to profit from this abundance of input are becoming commonplace. While aggregating such heterogeneous data [2005] is not typically complicated, accurate sense-making of the resulting data collection [2015] very often is. This is especially true as the number of totally different kinds of sensors [100] increases.

However, sensors [100] will still often disagree with one another, even if they are of the same type. Some sensors [100] are substantially more reliable in any given context than others, due to qualities including, but not limited to, physical position relative to whatever is being observed, type, state of repair, and their degree of direct appropriateness for the situation at hand. As a result, a certain amount of ambiguity is simply unavoidable. This is especially the case in scenarios [575] where there is substantial overlap of sensor data [2010] rather than “stitched-together” data from sensors [2010] covering contiguous regions with only some slight overlap at the boundaries; in other words, the scenario [575] that exists in pretty much any urban environment. Such ambiguity in large quantities is never good, but it is especially undesirable in mission-critical usages such as military reconnaissance, targeting, disaster triage, as well as public hazard identification and prevention.

At an abstract level, humans must be understood as complex sensors [100] that are capable of generating numerous types of data [2010] with devices such as smart phones. This includes, but is not limited to: taking pictures [2065] and video [2070], posting on social media or dedicated apps, textual commentary [2060], and calling 911 or a similar hotline with a verbal description. Furthermore, cell phones and potential other small devices that may become ubiquitous in peoples’ purses or pockets are likely to increasingly have more built-in sensors [100] than is the case as of this writing.

Unfortunately, despite our superior ability to make correct real world inferences, humans as sensors [1000] are very often unreliable. Reasons for this include, but are not limited to: subjectivity or deliberate bias, limitations in vision, hearing, cognitive ability, or other impairments, attention-seeking behaviors including trying to impress others (for example repeating or forwarding posts by others), temporary impairment due to alcohol or drugs, being in the pay of an organization whose purpose is to distort or mask the truth, and responding to perceived incentives such as social or financial ones.

Yet, despite these intrinsic flaws, humans-with-devices-as-sensors [1000] are an inescapable part of the future in sensor fusion systems [10] used for any kind of surveillance or reconnaissance. One of the core reasons for this is that humans, especially in an urban environment, can be very easily and quickly directed from one place to another by mechanisms as simple as a geofenced text message requesting urgent assistance. By definition, in urban environments, human sensors [1000] are plentiful. If we treat the set of humans present at a particular scene [405] of interest as being akin to a large array of traditional sensors [100], we may concern ourselves with the performance of the array rather than the reliability of the individual component sensors [100].

Including humans-with-devices-as-sensors [1000] - “human sensors” for short - is critical because a key and often overlooked requirement for optimizing sense-making abilities in sensor fusion systems [10] is ensuring the best possible data [2000] out of which to make sense for any particular situation in the first place. While sensors [100] such as security cameras, heat sensors, and drones [145] are often set up to provide a desired security level for a particular premises, in general public spaces nothing so comprehensive is likely to be present. Thus, an approach in which sensors [100] of different kinds, including human witnesses on the scene, are temporarily recruited to provide relevant data [2000] by a peer sensor [100] or component having the necessary recruitment permissions [550] and a higher priority requirement, becomes compelling. This peer-to-peer “recruitment" [545] can include anything from changing the flight paths of drones [145] to investigating a reported or detected anomaly, to changing the focus of fixed cameras such as those used for traffic, and blasting geofenced messages asking persons present at a scene [405] to take and upload pictures [2065] or videos [2070], or to answer certain questions [1170] (e.g. “doyou smell a strong sour odor?”). Once the scenario [575] has been properly identified to the desired level of certainty and is not considered a potential threat, the recruited sensors [100] will be released.

This patent application describes a sensor fusion and analysis system [10] that incorporates data from an arbitrary number and types of sensors [100] including but not limited to: footage from one or more drones [145], various forms of social media, geolocation data [2045] available from cell phones, fixed, portable, and wearable cameras, databases [6015] such as law enforcement information, foot and vehicle traffic models, traffic cameras, satellite images, and dedicated mobile or other apps. Indeed, any observable object which can emit data [2000] or manifest behaviors about/in a particular location [400] within a particular timeframe [3000] can in this system be treated as a sensor [100]. The greater the number and kind of such sensors [100] available to the system [10], the better.

Each raw data source [800] when combined with at least N >= 1 special purpose “readers” [525] that interpret or analyze them becomes N distinct sensors [100], which may be combined to create further sensors [100]. For example, a complex raw data source [800] such as a social media feed [305] might have one reader [525] for text [2060], another for images [2065], and still another for video [2070], and so logically constitutes N=3 sensors [100]. These sensors might be combined in the case of mixed media posts. In the case of simpler physical sensors [2200], such as sound or light sensors [100], in most embodiments, groups of sensors [100] can be coordinated through a controller [500] that reports collective results and may reorient or reposition its sensors [100] if doing so will produce a more comprehensive or accurate result. However, controllers [500] of an analytic nature will also be present in most embodiments to mediate among sensors [100].

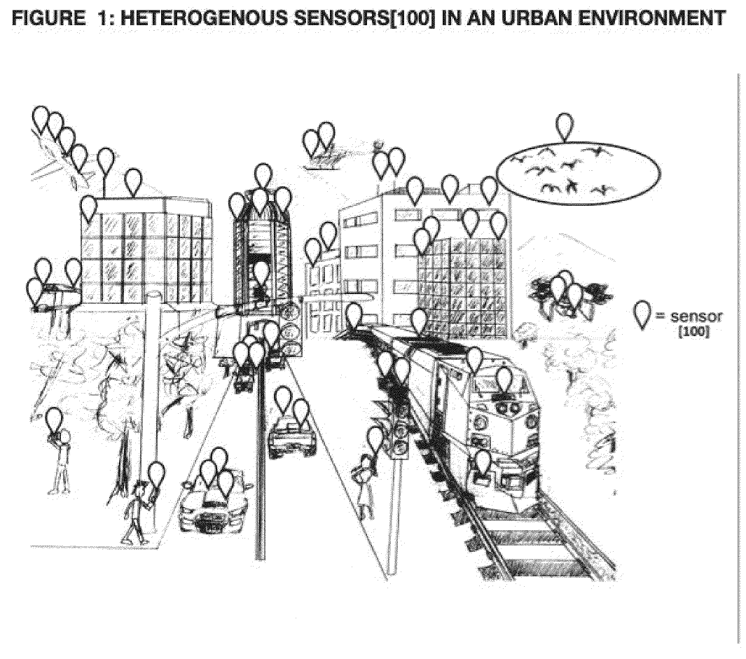

Sensors [100], or their controllers [500] when present (which we will also consider to be sensors [100]), subscribe to different event feeds [305] based on a set of master configuration rules [140]. Explicit sensor recruitment requests [540] occur in these event streams [305], however some sensors [100] might shift their focus independently of such a request [540] simply on the basis of the particular events in the stream [305]. In other words, both a “push” and “pull” model will be available by default. FIG. 1 shows an example of the types of sensors [100] that would be likely to exist in an urban setting and provides a conceptual sense of the possible density. Note that the term “sensor" [100] is being used in an abstract sense. For example, anomalous flight behavior of flocks of birds [105] in conjunction with appropriately equipped literal sensors [2200] can be considered a sensor [100], assuming that the behavior was observed by at least one literal sensor [2200].

The system [10] design very deliberately forces system architects to think very carefully about the definitions of the event streams [305] and events [505], in an abstract way. This is not a deficiency in either its design or its description here. The system [10] described herein is designed to function well in highly dynamic, chaotic and even dangerous situations such as wars, but really any unexpected situation that generates confusion and disruption. This choice of highly dynamic scenarios [575] as a primary use case has two important implications:
1. Such situations are by their various definition highly anomalous - in other words, rare. This means that statistical approaches — including machine learning techniques — cannot trivially be brought to bear since the sample size / amount of training data will generally not be anywhere close to enough to meaningfully use such techniques. Thus a more complex, hybrid approach will be required.
2. The most complex scenario [575] to architect for is that of large-scale battles in a war zone. This scenario in particular is incredibly dynamic, both in the minute-to-minute sense but also in the “technical surprise” sense of that which is true today may not be true in another week or month since war is a great accelerant for both technology development and technique refinement. The former means that sensors [100] both are frequently on the move and may have quite short lifespans in a battle zone. Furthermore, sensors [100] in general have a vastly increased chance of being physically damaged, and so malfunctioning in a variety of ways, not all of which can reasonably be predicted.

Lastly and importantly, so as to mediate the input provided by the human sensors [1000], the system [10] described herein contains a subsystem in which a distributed dialog system [1010] backs at least one and probably many instances of one or more mascot characters [900] who solicit information from human sensors [1000] present in a relevant physical area. In most embodiments, more than one mascot [900] personality will be used so as to enable the fine-tuning of the mascots [900] to both different subpopulations of human sensors [1000] and also different incident [570] scenarios. In most embodiments, such mascots [900] can act as Internet / social media personas, using social media and / or dedicated applications actively to solicit information from humans according to characteristics, including but not limited to, their current location [400], areas of expertise, or track record of observations [130]. In most embodiments, these mascots [900] can also be contacted by humans who have just witnessed some event [505] of note.

In almost all embodiments, a chatbot [1030] with full natural language understanding and generation capabilities will be preferred. However, also in most embodiments, the chatbot [1030] will not be limited to only the use of natural language, but can also show images [2065], video [2070], or use controls of different kinds as well. This is because if someone is confronted with a situation such as a fire, an explosion, a missile hit, or the like - or is watching the movements of troops, drones [145], or other materiel in a war zone - presenting them with a form to fill in, or a limited set of multiple choice options from which to choose is both impractical and inadvisable.

It is impractical because general user [1000] experience with forms beyond the most commonplace, such as filling out one’s address and payment information to make an online purchase, is poor. This is because the majority of online applications that contain such forms are very poorly designed. Each field in the form will normally have some kind of error checking, but such error checking often fails to consider all of the valid possibilities that may be encountered in the real world. In many cases, the specific intent of the field may be unclear. If it is a control that allows a choice from multiple options, perhaps none of the choices are obviously the right one, causing user [1000] hesitation. Or worse, the user [1000] chooses one of the provided choices nearly at random so as to be able to “submit” or otherwise continue. This is very undesirable in any kind of military situation. Yet, it is the outcome that would occur with a normal web interface.

Thus, in cases in which there is danger, such solicitation [1065] must extract the greatest amount of the most accurate information possible from the human sensor [1000], as quickly as possible. All three of these points really matter. The speed matters because it simply may not be safe for the human sensor [1000] to remain in the location [400] indefinitely. And because user [1000] patience is never infinite, even under mundane circumstances, extracting as much reasonably accurate information as a particular human sensor [1000] possesses, and no more than that, is in fact difficult. It requires combining different methods to assess the provided information a) according to its own internal consistency and real world plausibility, b) in the context of what is known about the particular human sensor [1000], if anything, and c) incoming information from other sensors [100] as well as other sources. For example, it is not likely to be useful to solicit information from a human sensor [1000] about which exact model of tank or drone [145] they may have seen in the distance if it is known that the individual in question has no military background and is nearsighted. Such optimizations are not mere niceties, but rather can mean the difference between achieving a clear understanding of an evolving real world situation vs a chaotic one soon enough to make a meaningful real-world difference.

### High Level System Architecture

The system [10] described in this application assumes a broad mesh network of heterogeneous sensors [100], which have the ability to communicate with one another in a peer-to-peer manner, as well as with other system components [535]. We mean “sensor” in an abstract sense: a sensor [100] can be almost anything that collects and emits data [2000] with at least reasonable accuracy. This is depicted in FIG. 1. For reference, we will refer to sensors [100] in a default embodiment as being one of the following high level types:
Physical sensors [2200] including, but not limited to, opto-electrical sensors, IR, and sound;
Human sensors [1000] - human users [1000] with communication devices;
Logical sensors [2210] - hardware and/or software components that interpret data [2000] from raw data sources [800] including, but not limited to, the Internet;
Indirect sensors [2215] - anomalies observed or detected by other sensors [100] that are suggestive, for example a large number of animals in a bounded region suddenly behaving oddly (screaming, for example, becoming ill or dying);

This is done by each component [535] posting a stream of events [305] that may be subscribed to by zero or more other components [535]. Events [505] which no components [535] currently “see” are trapped by an event catcher [580] in most embodiments. In some embodiments, the event catcher [580] will also trap events [505] for which no other components [535] have paired actions [3060]. In most embodiments, individual events [505] as well as the streams of events [305] emitted from different components [495] can be coded to be peer-to-peer only, sent to centralized components [535] only, for example analytical components [520] that perform substantial computations before emitting events [505] that cause actions [3060] to be performed by other components [495].

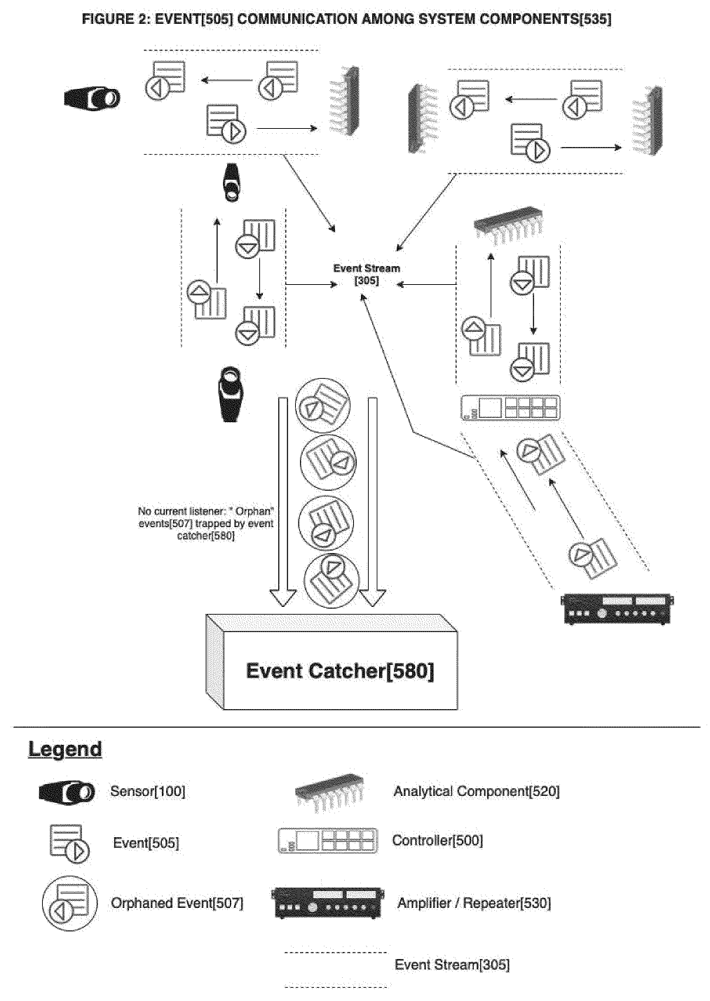

As depicted in FIG. 2, individual sensors [100] may communicate with analytic components [520] as well as with one another. Some sensors [100] may have controllers [500] from which they receive commands; in some scenarios amplifiers or repeaters [530] may be needed for the event streams [305] to reach other objects in the network.

The purpose of the communication among sensors [100] is to either obtain information about an object of interest [220] (or other anomaly), from one another, and/or to temporarily “recruit” other sensors [100] so as to get a better look at an object [220] or scene [405] of interest. What exactly recruitment [545] means as a practical matter varies by the type of sensor [100]. For example, many security or traffic cameras can have their orientations changed. In some cases, sensors [100] can be remotely powered on — or have their power level increased — when recruited and returned to its previous power state after it is released.

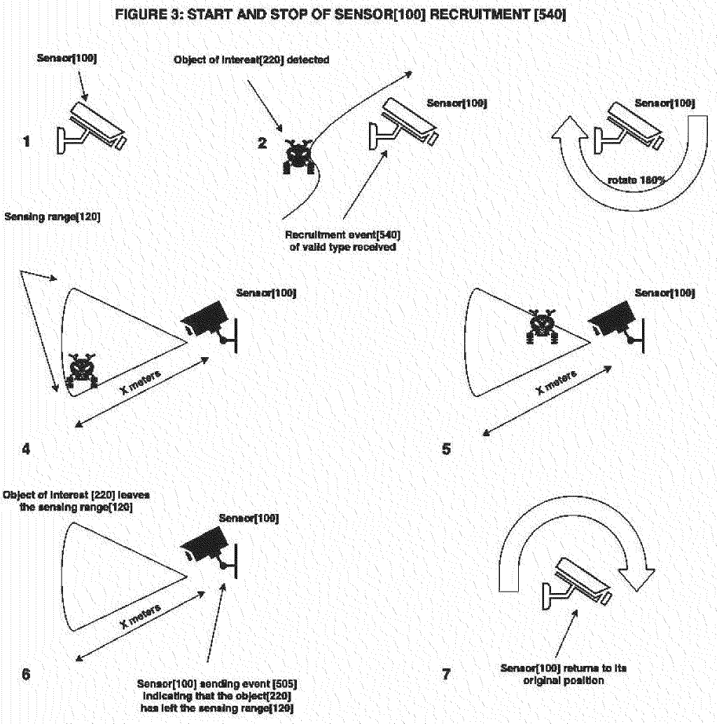

As depicted in FIG. 3, cameras can change their orientation as a result of being recruited [545] by another component [535]. When an object of interest [220] is detected that could be sensed by a sensor [2200] if it rotated, sensors [100] or other components [535] that are tracking this object of interest [220] can send a recruitment request event [540] to that sensor [100] asking it to rotate to the appropriate angle. If the sensor [100] in question is subscribed to the relevant event feed [305] and the object of interest [220] is of higher priority than whatever it is currently monitoring, the sensor [100] will perform the requested rotation. When the object of interest [220] leaves the sensing range [120] of that sensor [100], the sensor [100] will post an event [3015] to this effect. Depending on the embodiment, that will directly terminate the recruitment [545], cause the requesting component(s) [535] to send a termination of recruitment event [540], or allow the recruited sensor [100] to release itself once the need for it has passed. (Note that in most embodiments compatible recruiting requests [540] can be made concurrently if multiple components [535] have an interest in a particular object. In such situations, the highest priority is assigned from among the N > 1 recruitment requests [540] in most embodiments.

This is of course just one example of many. Cameras can also change their focus. Surveillance drones [145] may be dispatched to get a better view of a potential safety hazard, as can cameras mounted on cars or trucks. Human sensors [1000] may be requested to go to a certain area if they receive a request for assistance [3035]; if already present in the desired area, they may post descriptions of what they see, and take and upload pictures [2065] or video [2070].

In most embodiments, each sensor [100] of whatever kind will have at least the following communication abilities:
The ability to emit a set of specific types of event postings[510] and recruitment requests[540]. In most embodiments, these may be posts to an event feed[305] that can be listened to by an arbitrary number of sensors[100] and other components[495], or in direct communication with another sensor[100] or other system component[535].
A set of other sensors[100] to which the given sensor[100] will listen for events[505]. These can be static lists or dynamic definitions[700], for example all sensors[100] that are currently within a certain set of coordinates or possess a certain capability.
A set of analytical or other computational components[520], or other system components[535] to which the sensor[100] will listen for events[505] and send events[505]. This can likewise be a static list, or a definition[700] that binds dynamically.
Similarly, a set of independent event feeds[305] to which the sensor[100] will listen, if the given implementation permits event feeds[305] that aren’t controlled by a particular component[520].
A set of specific event post types[3020] for which it listens within the event streams[305] of the sensors[100] or other objects[220] to which it listens, and with which specific actions are paired.
And of these, a subset (partially- or fully-ordered in most embodiments) that will generate a request[540] for the sensor[100] to be temporarily recruited from whatever its standard function. This is initially a request[540] since there may be various types of contentions that in the worst case — a number of presumptively critical requests[540] competing with one another such that not all needs can be satisfied in a timely way — a human operator[1050] may need to prioritize. However, many embodiments will supply heuristics or other prioritization mechanisms so as to try to limit such cases. For example, in the event that there is scarcity of certain valuable resources such as drones[145] causing some recruitment requests[540] to need to be deferred, some embodiments will use game theoretic and other approaches similar to those described by Rashid, Zhang and Wang (2020)¹ to prioritize the recruitment.

Still, contention can arise for far more basic reasons. For example, any individual camera cannot be pointed in two opposite directions at the same time, nor would it be desirable to widely broadcast a message to all users[1000] anywhere near the area of an incident[570] that first asks them to go to one location[400], then another, and another in quick succession - or worse, alternating among them.

In many embodiments, once a recruitment request[540] has been accepted, the system[10] will block other recruitment attempts to sensors[100] it has just recruited for a certain preconfigured period of time[3000] - absent an override from a human operator[1050]. Furthermore, in many embodiments, if a path[200] of the object of interest[220] has been calculated, recruitment requests[540] along the path[200] will be coordinated by a component[495] that will try to optimize the mobilization of sensors[100] along the route of the path[195], by trying to optimize the recruiting[545] and release of each relevant sensor[100].

The logic of releasing recruited sensors[100] other than in the case of a “stop watching” event[505] can vary according to what is specified in the system configuration[125]. Possibilities that different embodiments may choose include, but are not limited to: releasing a recruited sensor[100] in the event that the object it is watching is stationary for more than a specified period of time[3000], releasing a sensor[100] after the object(s) of interest[220] have a prespecified level of coverage without the sensor[100], releasing a sensor[100] if it is redundant with one or more other sensors[100] and a new recruitment request[540] has been made for it, and if the object of interest[220] has been downgraded in a vector such as importance or urgency.

### Event [505] & Event Stream [305] Characteristics

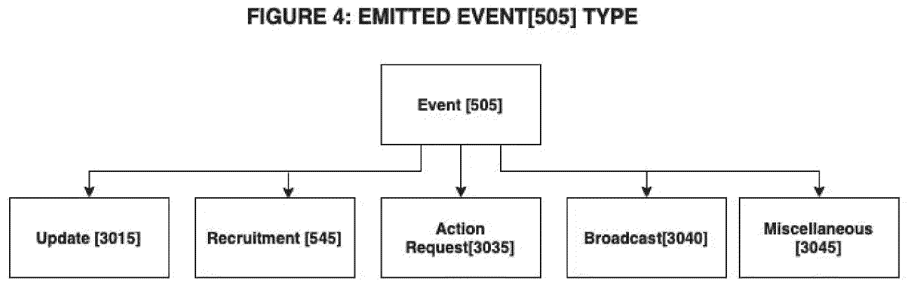

Events[505] will have the following minimal properties in most embodiments: name, description, content, unique ID, slot(s)[300], object(s) of interest[220], time, location[400], urgency score, importance score, and recruitment event[540] (Boolean). Event streams[305] will have the following minimal properties in most embodiments: name, description, unique ID, priority, and owner (the sensor[100] or component[495] if it is a dedicated feed, NULL if not). Some embodiments may allow non-dedicated event streams[305] to place constraints on the type of events[505] that may be posted to them. For example, an event feed[305] could only allow the broadcast[3040] of informational messages to users[1000], or allow only recruitment requests[540], update events[3015], user action requests[3035], other miscellaneous events[3045], or any combination of these. Many embodiments may opt for further categories as well. This is depicted in FIG. 4.

As previously noted, there may be mismatches between the event[505] types that are emitted by some sensors[100] or components[495] and those which are of interest to - or even interpretable by - any of the other sensors[100] or components[495]. In a large, highly decentralized system, this situation is difficult to completely avoid. In many embodiments, events[505] from event feeds[305] to which no sensors[100] or other components[495] are subscribed will be collected by a special purpose “catcher” component[580] that will endeavor to assess whether or not any of the events[505] likely require action on the part of a human analyst[1050]. Similarly, some embodiments will implement catcher components[580] to collect individual events[505] even from event streams[305] that do have subscribers but for which none of the subscribing components[495] have an action paired, nor are the events[505] recruitment events[540].

Such “catcher” components[580] may select different strategies for triaging these “orphaned” events[507]. These may include but are not limited to the following: events[505] that are explicitly coded by the emitting sensor[100] or component[495] as being urgent or the equivalent, events[505] from event streams[305] from sensors[100] that are either or both currently in a “recruited” state and / or have any kind of elevated importance status, parsing such events[505] lexically in the hope of interpreting them either by natural language meaning or similarity in content to known events[505], and events[505] that are either/both cascading and / or generating events[505] coded as increasingly serious.

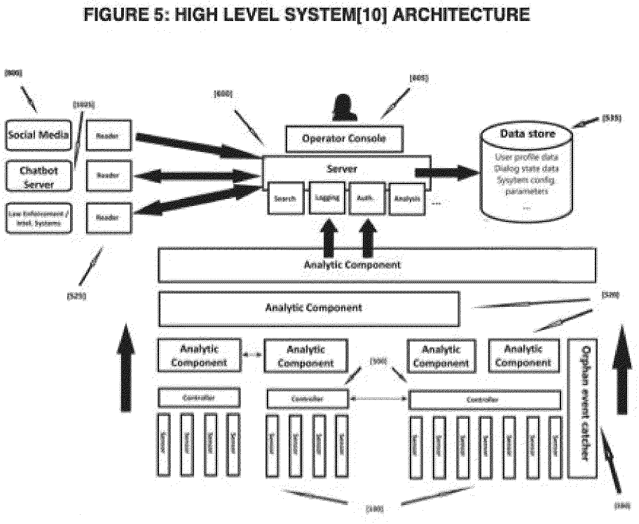

As can be seen in FIG. 5, in addition to sensors[100] of different kinds that may be layered, most embodiments will have the following other types of components[535]. Other embodiments may of course have additional ones.

Service components[610], such as those that query any data stores[1145] used by the system[10], the actual stores, authentication and logging components, as well as other services common in this class of system. The data stores[1145] include information on all users[1000] who have previously accessed the system[10] and dialog state[1155] information which in most embodiments will be persisted for lengthy periods of time since reactivation / resumption of the dialog session[1005] even months later may be advantageous in some real world circumstances.

Analytical components[520] that are invoked to perform specific types of analyses. These components[520] may be layered on top of one another. Examples include, but are not limited to:
Path[195] identification; associating a specific probable path[195] to an object of interest[220]. (Paths[195] are discussed in a subsequent section).
Data “unification” [2020] of different kinds - for example, determining that a vehicle that has been designated as an object of interest[220] is likely being driven by a person of interest[1055], since different sensors[100] indicate that both are traveling on the same path[195] (in close proximity).
Data aggregation[2025], for example identification of anomalous behavior being manifested by multiple humans, animals, or vehicles in a given bounded area[405]. Detecting a group of people all looking or orienting their smartphones in the same direction, running away from something, covering their faces, or hitting the ground can be used to make inferences about both the presence and type of some kind of public hazard. Similar logic applies to animals or birds present at the scene[405] whose reactions may likewise be telling. Such components[520], though analytical in nature, are in essence a form of sensor[100].

Control and interface components that interface with other systems that provide relevant information, such as those belonging to law enforcement, military, volunteer organizations, or news organizations. The outside systems often will be the source of data[800] such as that indicating a particular object of interest[220] has been determined not to be a threat[1100], or when a new object of interest[220] has been identified to start tracking.

Operator console & application[605], which allows credentialed users[1000] to perform tasks such as specifying particular objects of interest[220], and changing system configurations[125].

Mascot avatar social media accounts[615] and apps[620] backed by a dialog system[1010] that solicit information directly from the public.

### Paths 195

The notion of paths[195] is critical for many of the relevant use cases for the system[10]. As the name suggests, a path[195] is a physical route that there is good reason to believe an object of interest[220] is likely to travel within a bounded period of time[3000]. While certain types of incidents[570] such as electrical fires or earthquakes are essentially spontaneous from the point of view of almost all sensors[100], most types of incidents[570] that have a human actor component greatly benefit from the notion of a path[195].

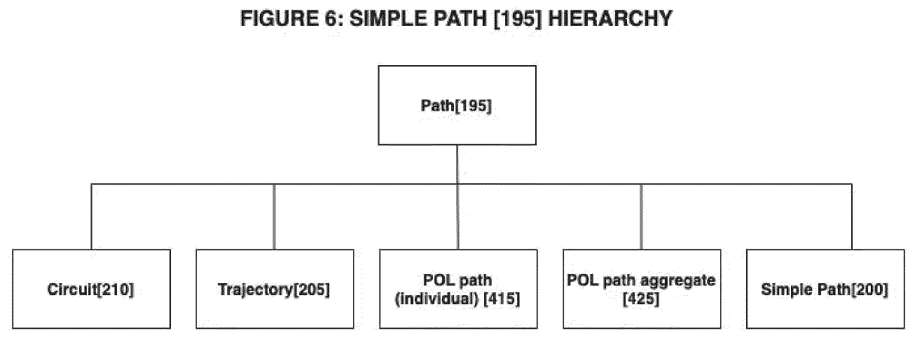

Most embodiments will offer four broad classes of path[195] so as to more accurately describe different types of situations as shown in FIG. 6.

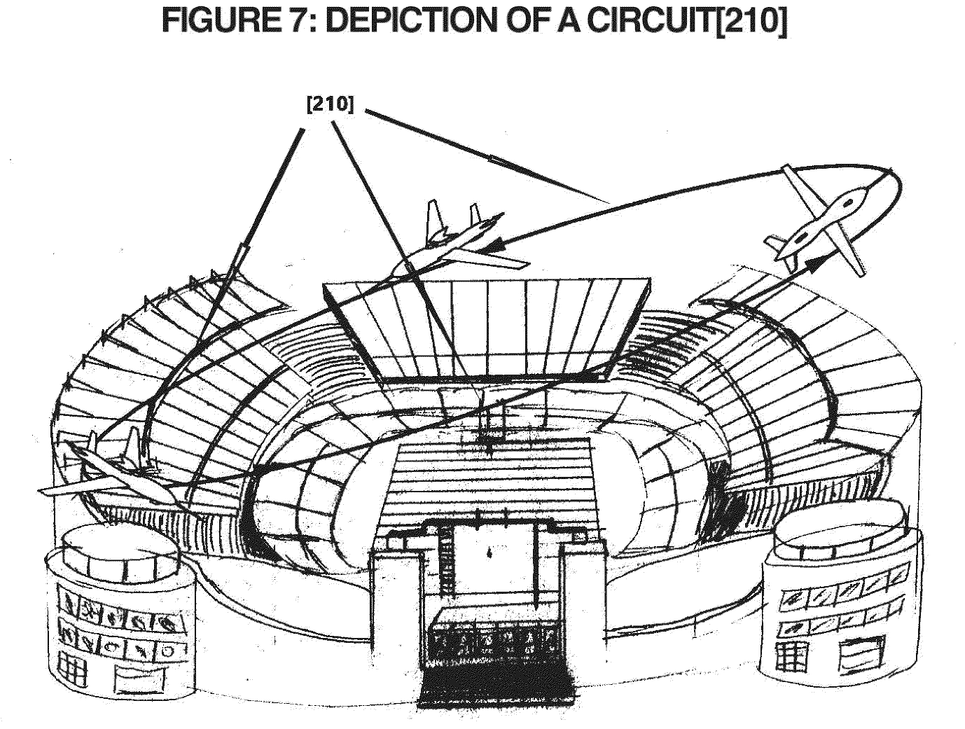

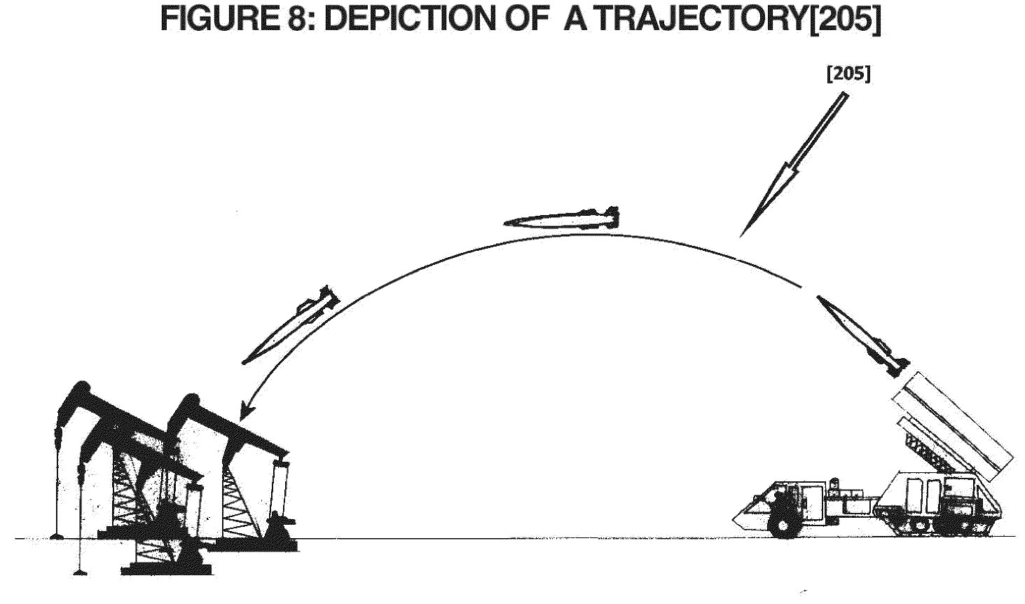

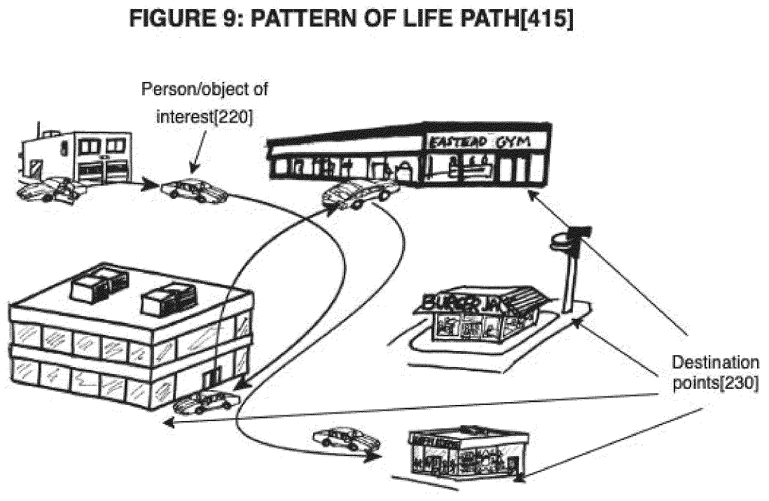

The first type of path[195] is a circuit[210]. As depicted in FIG. 7, a circuit[210] is a path[195] that repeats or loops and is therefore highly predictable within a given window of time[3000], for example a drone[145] circling a stadium during a concert. By contrast, a trajectory[205], as seen in FIG. 8, is meant and determined in the pure mathematical sense, such as a ballistic missile being fired whose path past a certain point is largely predetermined unless destroyed. The most complex type of path[195] is the pattern of life path[415] (POL) as shown in FIG. 9. This is a semantically describable route that spans at least two points in space and may span an arbitrary number. Some common examples of such pattern of life paths[415] include workers headed to work, spectators heading to a sporting event, or mailmen delivering mail on their regular routes.

Simple paths[200] handle the case in which an object of interest[220] has left point A and is observed heading in a given direction, but the destination point(s)[230] are not trivially predictable In other words, a simple path[200] is either not part of any discernible pattern, is part of a very sparse pattern -or else a spontaneous pattern in which N many related objects of interest[220] are moving in directions that suggest that their destination points[230] will intersect.

In most embodiments, objects of interest[220] will have most of their properties vary by their class. For example, vehicles, packages, people, and equipment can all be objects of interest[220]. They can all move, be moved, and / or cause other things to move, and they can all potentially cause harm or risk. Almost all embodiments will support arbitrarily deep type hierarchies. For example, there may be quite a number of categories and subcategories for human objects of interest[1055]. A new category or subcategory will be warranted in any case where behaviors and the best actions for the system[10] to take will differ from one category to the other. For example, a person of interest[1055] because of terrorist connections is different from a gang member in probable behavior and objectives. However, in most embodiments, objects of interest[220] will at the root class have the following attributes: unique ID, category, creation date, and creation type (e.g. different types of dynamic vs. manual), and any location[400] and path[195] information.

Pattern of life paths[415] will have the following attributes in most embodiments: name, object type(s) associated with it, unique ID, individual object vs. an arbitrary number, standard timeframe[3000] of occurrence (if applicable), list of destination points[230] that have been associated with the path[415], ordering information with respect to how the points may be ordered to one another, full average time to execute path[415], variance of that time and similarly for time spent and variance at each destination point[230], and which of these points are of the same equivalence class.

For example, someone might regularly stop off at a drugstore, a convenience store, or for coffee on their way to work. But, depending on a variety of factors such as the weather, what time they must be in the office on that day, whether they are on their cell phone, traffic conditions if they are driving, which instances of these stops they make in what order — if at all on that day — may all change. (While people have their habits, urban and suburban environments offer many choices in close physical proximity, so it won’t always be the very same drugstore, mailbox, etc.)

Thus, the actual destination points[230] visited along a pattern of life path[415], and potentially their order, may vary by instance of the same logical POL path[415]; for example, on any given day, someone might run errands in differing orders. Thus a POL path[415] should be considered an approximation of probable behavior rather than a prediction of the exact location of a person or object[220] at a given time. In most embodiments, POL paths[415] may be either manually entered into the system[10] —presumably based on behavior observed outside the system[10] boundary — or observed repeatedly by system sensors[100], then computed by one of more system analytic components[520]. Most embodiments will archive manually-entered POL paths[415] after a configuration-specified period of time if they are never observed in reality. This is because it’s not good system[10] hygiene to expand the number of computational possibilities in ways that are demonstrably not useful in the given context; it incrementally increases complexity, and thus decreases system[10] performance.

POL paths[415] are typically of two main types from a use case perspective: those that represent the routine or repetitive actions of a particular individual of interest[1055], and those which represent general movements of a particular population whose POL paths[415] share a high degree of commonality. Such aggregate POL paths[415] are useful for identifying potentially perturbing contexts in a particular environment that may change travel time estimates — for example, that traffic will be greater on the roads during rush hour — and for assessing the risk of an incident[570] based on actors of interest[1055] apparently converging on the same location[400] within a short time window[3000].

A scene[405] is a description of a bounded, connected physical area for purposes of observation. Scenes[405] may be statically or dynamically generated in most embodiments; their spatial definitions may be statically or dynamically determined, similarly. For example, a statically-defined scene[405] centered around a sensitive site might be defined. However, this statically-defined scene[405] might have its bounds dynamically expanded in the event that one or more objects of interest[220] are likely to enter within a pre-set time window[3000] based on the current path[195]. Different maximum bounds based on either estimated arrival time of object(s) of interest[220] or physical distance may be set for different presumed types of incidents[570] or classes of location[400] in most embodiments.

In most embodiments, scenes[405] will have the following attributes: name (if statically-defined), unique ID, description (if statically-defined), geographical boundary description (exact expression may vary by embodiment), objects of interest[220] (if dynamically-defined or dynamically-expanded), and start and end time (also if dynamically-defined or dynamically-expanded).

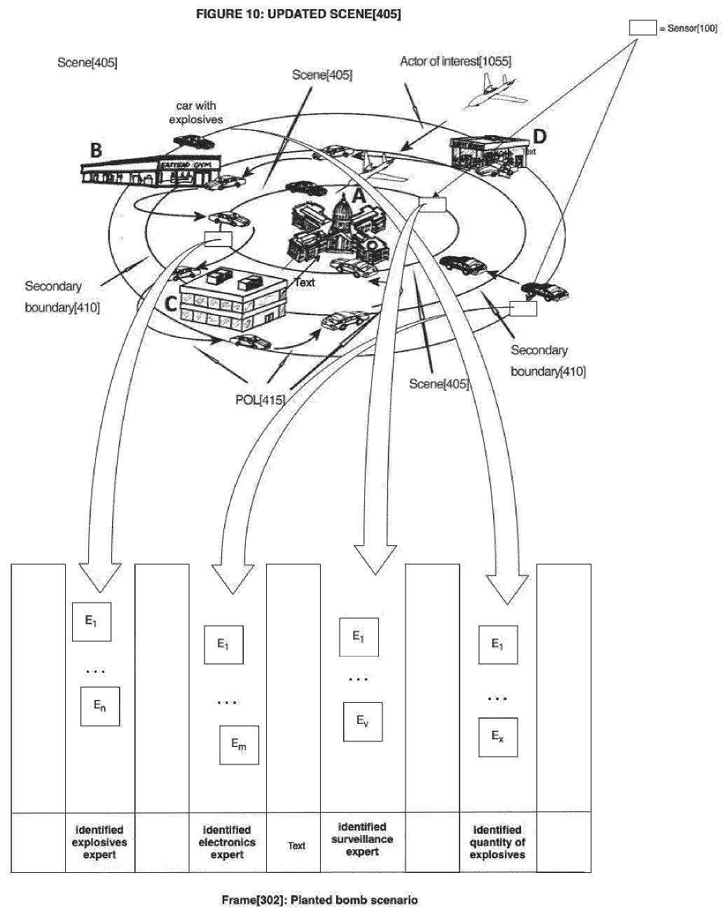

Inferences as to the movements of objects of interest[220] in most embodiments will generally be made on the basis of the combination of simple paths[200] (e.g. target X was seen getting on a train that is scheduled to arrive at or near the scene[405] within the next 10 minutes), circuits[210], trajectories[205] or patterns of life paths[415] as defined above; any known perturbing factors that might cause delay will be factored in in most embodiments. As depicted in FIG. 10, most embodiments will calculate and display the earliest realistic point in time at which the different actors of interest[1055] who are currently being tracked and are presumed to be en route to the scene[405] are likely to arrive there. In this sort of situation, most embodiments will presume that there is a potential incident[570] of some kind in progress, or at least being prepared. In addition, in some embodiments, human operators[1050] with the necessary permissions can directly assert the likelihood of an incident[570] in a particular timeframe[3000] in a certain area based on intelligence received. In such a case, relevant sensor recruitment[545] will proceed as it would had the system[10] organically detected a potential risk, or as otherwise authorized by the human operator[1050].

Since tracking objects as they move along a path[200], path of life[415] identification, calculating missile trajectories[205], detecting persons[1055] and other objects of interest[220] that have already been identified, and other surveillance-related capabilities mentioned here have many well-developed techniques that would be suitable for use in the system[10] but are nonetheless still rapidly advancing in some cases, we leave the different embodiments to choose for themselves their preferred methods in these regards.

Many embodiments will support the definition of a set of conditions that if met suggest an increased likelihood of a particular kind of incident[570]. In particular, this applies to types of incidents[570] that involve the coordination of multiple people, as well as potentially equipment or materiel - in other words, N many objects of interest[220] about which certain properties are known. For example, if the preparation of a particular type of incident[570], a terrorist attack, generally requires persons of different skills (e.g. explosives, electronics, surveillance) plus two truckloads worth of explosives, detecting a group of persons of interest[1055] that correspond to these different skills along with one or more trucks would trigger an operator alert[1060] that corresponds to the specific type of incident[570] FIG. 10 shows an example of this case in which three different persons of interest[1055] known to have very specific types of expertise and at least one object of interest[220], an open-backed truck hauling what may be a cargo of explosives are all detected in or approaching a scene[405]. Update events[3015] announcing each of these things are received from sensors[100] in this example, filling all of the slots[300] of the frame[302] corresponding to the scenario of a pre-planted bomb.

Many embodiments may additionally choose to use machine learning or hybrid approaches. However, it should be noted that many of the types of events[505] in question are fairly rarely occurring, and so may not realistically be suitable for machine learning or other statistically-oriented approaches.

### Slots 300

A slot[300] is a common term used in knowledge-based systems. Objects of types that are represented in such systems have a set of attributes associated with them. The values of these attributes, to the extent that they are available, are placed into “slots"[300] and used to identify and subsequently handle different instances of the given type. In the system[10] described here, slots[300] will frequently be empty for at least some period of time. A simple example of this is a vehicle that is sensed far off in the distance. Its license plate will not be readable until it comes into range of a sensor[100] able to read it.

In many such systems[10], including the one described here, a “slot"[300] may only be partially filled and / or only partially express a complex reality. For example in the latter case, if the object type “car” had a slot[300] for color, and that slot[300] is filled with the value “black” but the car in question had extensive multi-colored paintings on it, the slot[300] data would not provide a fully accurate description of the car. A slot[300] may be (only) partially filled in a variety of ways. These include, but are not limited to: partial reading of something, like a license plate, or a value[5010] that is an estimate or guess in the face of ambiguity.

In most embodiments, slots[300] may contain hierarchies of other slots[300] to an arbitrary depth. In many embodiments, the slot[300] composition can be adjusted dynamically so as to react appropriately to the data[2000] that it is receiving. A primary motivation for this is the problem of the “complex reality” illustrated by the multi-colored car example. Most cars are not multicolored, and most cars don’t have text painted on them, but some do. Although some such variations can of course be captured in advance, it is pragmatically impossible to capture them all. (Even just in the case of cars, there are dozens of such examples, including flashing lights attached to different parts of the car, signs, racks, speakers or other objects attached to the roof, different kinds of hub caps, and sport team, national, or other flags, just to name a few).

In these embodiments, continuing on with the above example, persistent conflicting color data[2000] from different sensors[100] - and / or even conflicting data[2000] from the same sensor[100] will result in a new set of one or more slots[320] under an existing color slot[300], if one is not already present. In most embodiments, how this is done will depend on the type of parent slot[315]. For example, “color” is visual. In most embodiments, visual slots[322] will dynamically be updated by using machine learning techniques of their choosing to detect regions of different colors. (Even in the event that such analysis is totally unsuccessful in a given instance, the organically-developed structure of the slot tree[325] will likely still be useful for training purposes.) Each such detected distinct region then becomes a new child slot[320] of the parent[315]. In some cases, the ML may be able to automatically assign labels to the new slots[300]. If some of these regions contain readable text[2060], in most embodiments a new child slot[320] will be automatically generated and its contents will be OCR’ed. The new text slot[300] will be considered filled if the textual content[2060] is identified with the system configuration-required minimum level of confidence. Likewise for regions that contain something that is a recognizable logo or insignia that may be present in the system’s[10] data collection[2015], or otherwise searchable in an outside system. In the event that what was initially detected as a region actually contains more than one recognizable item such as a logo or text, new child slots[320] will be generated accordingly.

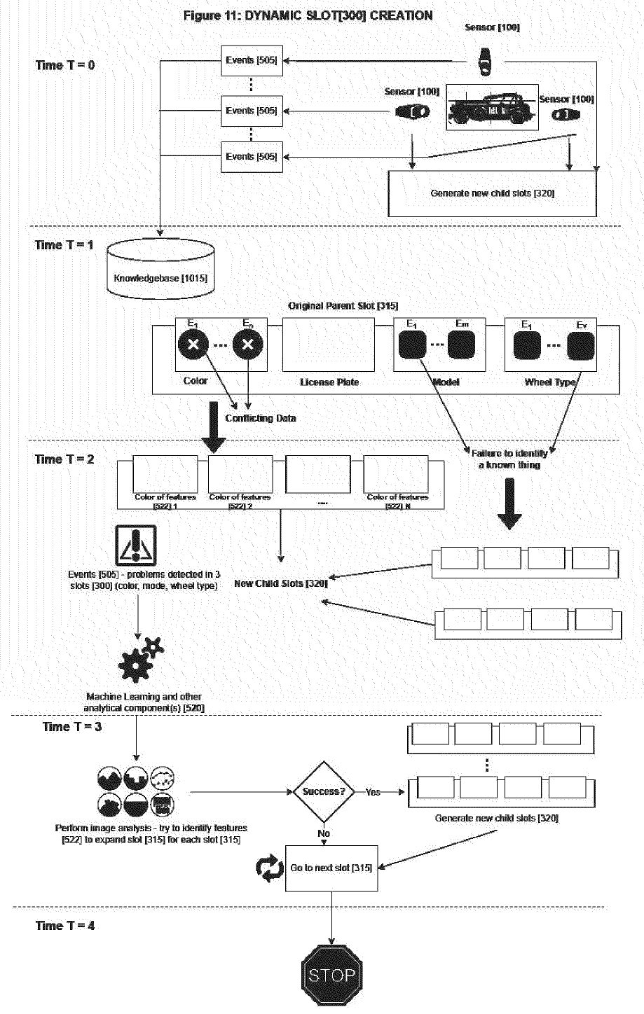

FIG. 11 depicts a somewhat related case in which an embodiment of the system[10] is confronted with 1920’s era car driving down the street. No such car type exists in its knowledge base[1015] or is easily identifiable otherwise from outside systems that it normally draws from. The classic car has a detectable wheels object in unexpected places and numbers. It is blocked into solid colors in unexpected ways. And as for the car model, without the necessary information about classic cars, most embodiments would likely fall back to trying to construct an answer by piecing together optional add-ons to cars that it does know. Thus in this example, three existing slots[315] would likely be expanded into child slots[320] in order to best describe the “novel” object.

In most embodiments, objects of interest[220] may be created in a number of ways, including but not limited to, the following: a) any type of analytic component[520], or combination of analytic components[520], including ML, rule-based, and pure statistical approaches which may be used to identify potential objects of interest[220] dynamically and to fill their slots[300] to the extent possible, b) system users[1000] with appropriate permissions can also manually identify objects of interest[220] or insert data[2000] into slots[300], c) information may be fed from an outside trusted system indicating that a particular object of interest[220] is entering a particular area, and d) trusted users[1000] may be awarded credentials to identify certain types of objects of interest[220]. More broadly, objects of interest[220] may be determined in numerous ways, including by their type, a specification for an individual person or object[220], their current location[400], POL path[415], circuit[210], or trajectory[205], behavior suggestive of malign intent or that which is simply anomalous - or any combination of these.

Almost all embodiments will presume that the same object of interest[220] is likely to be identified via more than one method and so will provide data unification[2020] mechanisms, including but not limited to: flagging operator alerts[1060] when there are object instances[225] with slot[300] values that are too similar to one another and dynamically merging the instances[225] with an auditable log. Note that we mean “object"[220] in an abstract sense; for example, a fire is an object[220] in this sense insofar as it is a concrete, detectable, bounded object[220] within an image[2065] or other data[2000] format. Likewise for aggregate objects[220], such as an unexplained crowd of people.

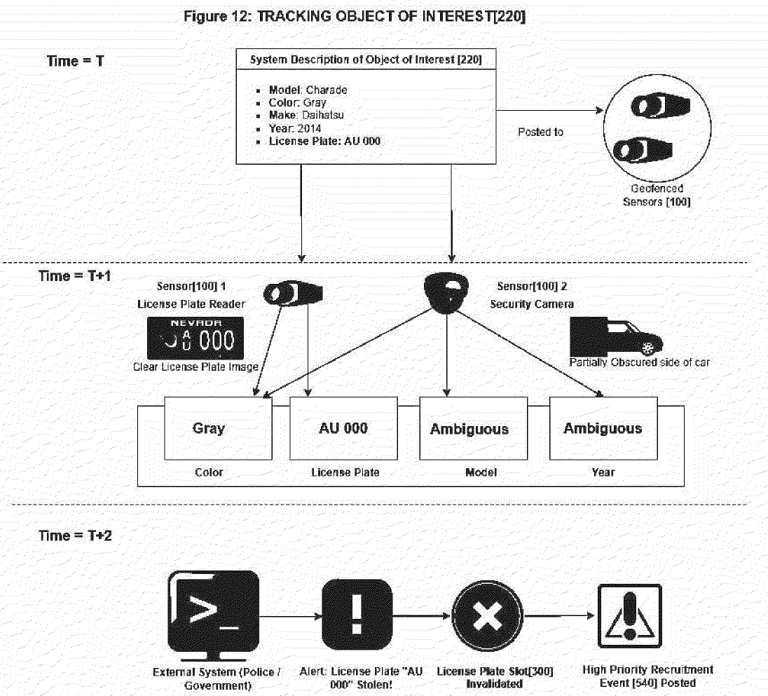

As shown in FIG. 12, when an event[505] announcing a search for a new object of interest[220] of a specified type with particular characteristics in a particular geofenced region, sensors [100] within this region who are subscribed to the event feed[305] will endeavor to fill the relevant slots[300]. However, as shown in the example, even if a very specific slot[300] such as “license plate” is 100% filled by dint of a very clear image[2065] of the car’s license plate, the slot[300] may be logically invalidated (as opposed to having its contents become invalidated) by the posting of an update event[3015] from a law enforcement or similar system that indicates that the license plates had been stolen. At this point, a new recruitment request event[540] will be sent out by the slot[300] that would likely have a higher priority (assuming that system configuration rules prioritize objects of interest[220] in the event that the car or the license plates have been stolen.)

In most embodiments, each sensor[100] will assign value(s)[5005] to at least one slot[300] for each object of potential interest[220] it can detect. This depositing of data[2000] in slots[300] may be done in a single event posting[510] from a given sensor[100], controller[500] or analytic component[520], several, or continuously for a bounded continuous period of time[3000]. In most embodiments, updates to individual slots[300] from the observing sensors[100] will continue to be published about the object[220] by any sensor[100] that can sense it until it becomes uninteresting as the result of a global “stop watching” event[505] posted by an authoritative source[5015]. Such an event[505] could be posted for a number of reasons, including but not limited to: the object[220] has left the area in which there are sensors[100] and / or which is of special interest, the object[220] has been determined to not in fact be an object of interest[220], or the object[220] has been apprehended by authorities. Some embodiments will send “stop watching” events[505] to individual sensors[100] in the event that enough other sensors[100] have a better vantage point.

In most embodiments, each slot[300] will have rules as to what constitutes reliable and sufficient data[2000] such that it will report being filled. Such rules can be manually assigned or be assigned automatically by any type of ML or other desired method. For example, in most embodiments, a slot[300] could require that the object[220] is detected by a sensor[100] that is within optimal sensing range[120], or by at least two sensors[100] making consistent observations[130], or at N points along a path. For slots[300] that require continuous measurement such as “path"[195], a slot[300] is said to be filled for a particular interval of time[3000] (e.g. at time t=x, the object[220] was detected at location Y). Slots[300] of this type will typically have among their rules policies for dealing with gaps in observations[130], should such arise. These policies dictate whether or not the slot[300] is considered to be filled as of the current time t.

Almost all embodiments will allow slots[300] to declare themselves partially filled to varying degrees and have different operating logic according to how filled — or how well filled — they are. However, different embodiments may choose different approaches as to how many dimensions are associated with the slot[300] state. Options include, but are not limited to:
Assessed quality of information[2000];
Quantity of information[2000] across number of sensors[100];
Quantity of information[2000] across number of different kinds of sensors[100];
Metrics of disagreement among reporting sensors[100], time-limited in most embodiments;
Assessed certainty of information[2000];
How much of the slot[300] has been filled;
Recency of data[2000];
Any combination of these.

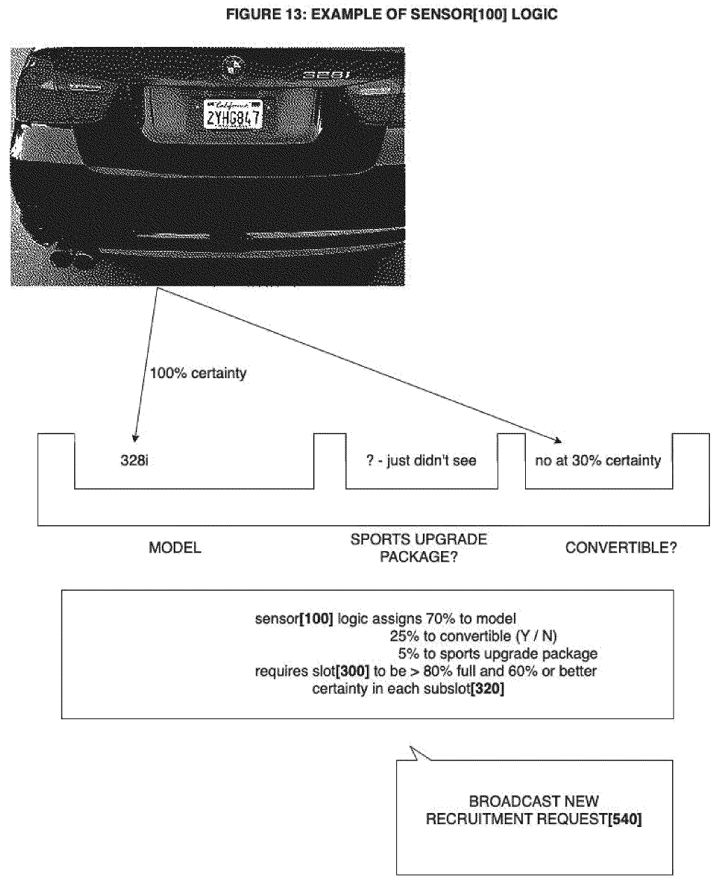

FIG. 13 depicts a very simple case of this in which a slot[300] relating to the model of car has three components: the main model number and two options to that model, whether or not the car is a convertible and the sports upgrade package. In this example, the slot logic[330] causes a new recruitment request event[540] to be broadcast since the slot[300] fails to fill by its own rules.

In most embodiments, an arbitrary number of sensors[100] and other components[495] will attempt to fill one or more slots[300] of objects of interest[220] within their sensing range[120]. Which slots[300] and how many slots[300] will depend on both the properties of the sensor[100] type — a heat sensor[100] can’t do facial recognition for example — and of these, which slots[300] are fillable at time t based on the combination of the requirements specified for the particular slot[300] and the goodness of the information[2000] that the given sensor[100] can currently provide.

Even with such restrictions in place, slots[300] will often receive partially or even totally contradictory information[2000] from sensors[100] and other components[495]. Reasons for this may include, but are not limited to the following: errors and malfunctions, visual, signal, and other obstructions or jamming, sensor[100] or logical limitations, novel object type, and camouflage attempts. In many embodiments, slots[300] will be allowed to have their own conflict resolution logic, including when to escalate to a human operator[1050]. A preferred embodiment will use the sensor fusion engine[155] described in the following section.

However, in the worst case, sensor data[2010] may simply be in direct conflict in such a way that it cannot be automatically adjudicated by the slot logic[330] beyond simply tagging the existence of the conflict. In cases in which the conflict is persistent — that is, as the object[220] in question traverses space, the sensors[100] observing it remain in conflict — in most embodiments, parameters defined in a system-level configuration file[125] will determine what action will be taken based on the estimated threat level posed by the object[220] in question. In most embodiments, this threat level will be provided in configuration parameters or rules, which may in turn specify the analytic component[520] from which the threat level (or constituent pieces of it) will be taken. For example, the slot[300] might send a recruiting request[540] that could cause a sensor[100] array to reorient or dispatch a drone[145] to better assess the situation.

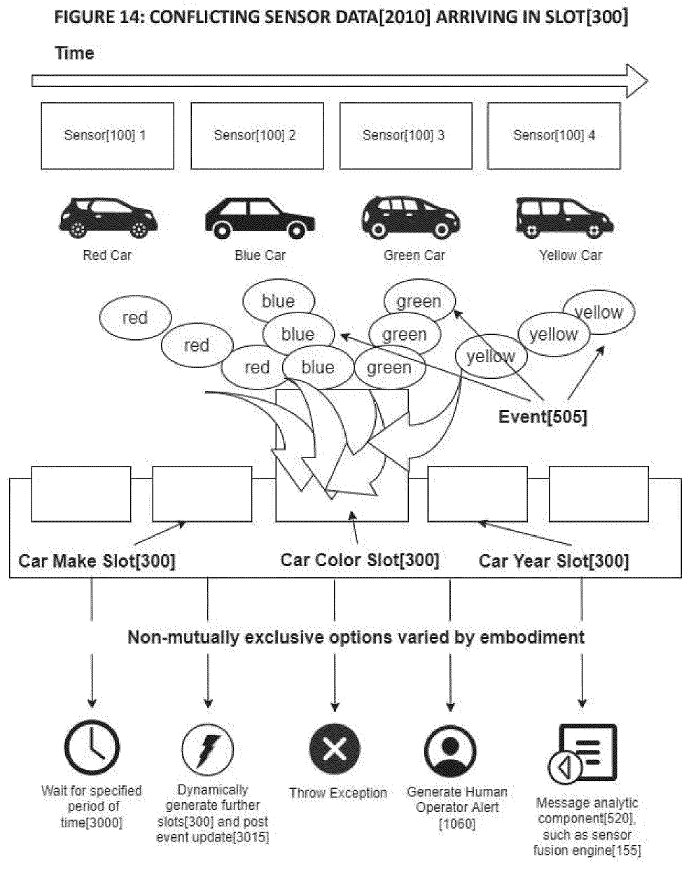

A simple example of this is shown in FIG. 14. In it, N many optical sensors[100] tracking the same car within their respective sensing ranges[120] each persistently provide directly conflicting data[2000] with respect to the color of the car in question. The “car color” slot[300] receives all of this conflicting information. In most embodiments, the slot logic[330] will have the following options:
Dynamically expand into further slots[300];
Send the conflicting data[2000] to one or more analytic components[520] that may be able to resolve the discrepancy;
Wait a pre-configured amount of time[3000] to see whether the discrepancy is persistent, as opposed to being the consequence of some passing phenomenon, for example some kind of jamming;
Throw an exception indicating a potential system[10] anomaly;
Generate an alert[1060] to a human analyst[1050];

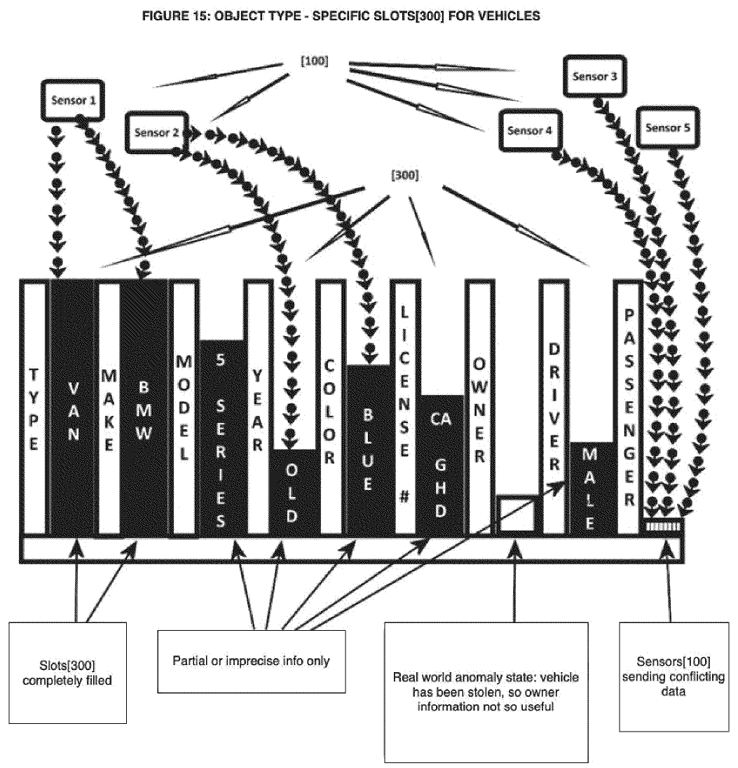

FIG. 15 provides an example of object-type-specific slots[300] being filled by the event streams[305] emanating from multiple sensors[100] while they are capable of observing the objects[220] in question. The simple example depicted below is that of a vehicle. Vehicles are commonly thought of as having a basic type, (such as van, SUV, sedan, truck or sports car), a brand, a model, a year, a license plate, a registered owner, and in any observation period, a driver, and potentially one or more passengers.

Most embodiments will provide for specific slots[300] being disqualified in a given instance if appropriate. For example, depending on how exactly the “owner” slot logic[330] is defined, a vehicle that is known to have been stolen may have its owner slot[300] logically invalidated (as opposed to having its contents become invalidated), or the slot[300] may be fillable if the driver can be reliably identified based on facial recognition or other data[2000] - that is, the driver may be treated as the de facto owner of the vehicle.

[image]

A default embodiment will provide the following generic slots[300] described below. Note that some slots[300] may be mutually exclusive with one another. Other embodiments may use other slots[300] from these.

Known timestamp[3010] of datapoint such as a reliably timestamped photograph[2065], a social media post[2040], any electronic sensor[100] reporting its location[400], and so on; a direct observation[130] that will be treated as fact, until / unless challenged by other “factual” data[2010] from an equally reliable sensor[100] within sensing range[120] of the target.

Inferred timestamp[3010] of datapoint, which is the case that exists whenever one or more inferences are being made by one or more sensors [100] or other components[495] as to the timestamp[3010]. Such classes of inferences include, but are not limited to, estimating the timestamp[3010] on the basis of time elapsed since a prior observation[130] at a known location[400] against a path[195], circuit[210], or trajectory[205], parsing the text[2060] of social media posts[2040] or other electronic data, being able to bound the timestamp[3010] by a pair of events[505] (for example, a particular photo[2065] or video[2070] must have been taken after Event X but before Event Y based on its content), or estimating the timestamp[3010] of a photo[2065] or video[2070] based on the angle of the sun.

Known location[400] at timestamp[3010], which is the location data[2045] from direct observation[130] or by a sensor [100] within sensing range[120] of the object[220] that is to be treated as verified.

Inferred location[400] at timestamp[3010], which includes, but is not limited to, inferences such as estimating location[400] at time t + 1 on the basis of the location[400] at time t and the apparent path[195], trajectory[205], or circuit[210], parsing text[2060] that asserts the author’s location[400], identifying a location[400] from a posted image[2065], and parsing text[2060] that implies the location[400] (e.g. “I just heard a loud bang”).

Object particulars slots[300], which may include the type of object[220] identification such as a model number and / or license plate, identification of a particular individual[1055] or target being sought (e.g. man with blue jacket carrying large package), or characterization of unknown persons or objects[220] at a given location[400].

Context identification[4005], or identification of temporally-limited contexts[4005] such as traffic accidents[570], events[505] such as parades, protests, large sporting events, or anything that perturbs normal movement and behavior around a given location[400] during a given time period[3000]. A context may also be periodic, such as rush hour or a major holiday. Knowledge of such events[505] will be obtainable in most real world instances. However, most embodiments will also employ ML and other techniques to ascertain the presence of any meaningful perturbing context. This is necessary since failure to factor in significant environmental context can cause faulty inferences to be made by analytic components[520], and because it can impact path[195] and hence arrival time calculations. By default, the context slot[300] will have a null value. Note however that multiple contexts can apply at the same point of time.

Path[195] identification, which is the trajectory[205], circuit[210], or POL path[200] that observed objects[220] or persons[1055] appear to be on, for example a drone[145] repeatedly circling a stadium during a game. The default value in most embodiments will be NULL.

Intention[310], which is an enumerated type slot[300] that may be used to prioritize targets[220] to watch in the event of resource contention. Possible values can include “attack”, “hostile surveillance”, “friendly surveillance”, “scientific” and “commercial”. It will generally have a default state of “unknown”.

In most embodiments, a value[5005] that is supplied by a reliable sensor[100] making an observation[130] within its sensing range[120] will take precedence over values[5010] which are derived on the basis of some kind of inference, such as NLU identifications of a reference to a location[400] in a social media post. The former serves as training and quality assurance data[2000] for the latter.

However, an identification of an object[220] that is deemed to be unreliable because of distance or visibility can be rejected even from a highly reliable sensor[100]. An older value can be superseded by a newer, more accurate one as an object of interest[220] travels closer to a sensor [100]. Different implementations may rely on different combinations of strategies to assess reliability. While slot logic[330] provides one means to make such decisions in most embodiments, the overall system[10] architecture described here is layered in order to facilitate this. For example, sensors[100] or controllers[500] may each report their own certainty levels, and may be graded for fixed distances of visibility under a given set of conditions. Controllers[500] likewise can have their own logic for sense making out of the inputs arriving from the various sensors[100] under their control. One or more analytic components[520] may be present to mediate among controllers[500].

Controllers[500] will often be used in the case of simple sensors [100] that are unable to perform these and other logical functions. However, controllers[500] may also be present in order to mediate the collective results within and among arrays of sensors[100] in different locations[400], generally but not necessarily of the same kind, likewise for analytic components[520]. Controllers[500] may also be hierarchical; there can be an arbitrary number of layers of them. Certain slots[300] such as “intention” that often will require some form of inferencing will generally be filled by controllers[500] or analytical components[520] rather than by single sensors[100]; simpler sensors[100] would generally lack the ability to fill such slots[300]; that is, they would neither receive requests[540] to do so, nor be allowed to respond if a simple sensor[100] did.

While adding more sensors[100] and layers of controllers[500] and computational components[520] is bound to create more conflict among different components[495], and so greater ambiguity in some sense, the sheer storm of events[570] relating to objects of interest[220] when something is going on alerts human analysts[1050] to an impending risk. Furthermore, the greater the number of sensors[100], especially well placed ones, the greater one’s expectation that there will be a convergence of sensor[100] output.

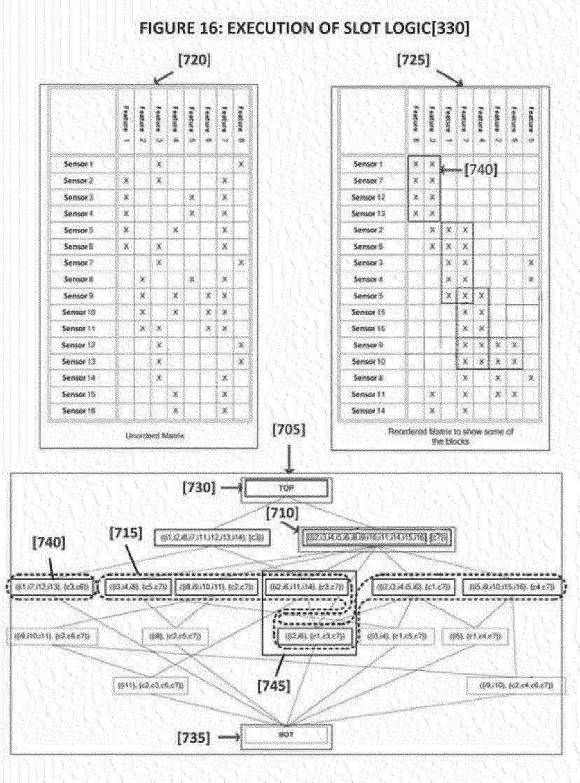

Otherwise put, as shown in FIG. 16, a significant chunk of sensors[100] focused on the same object(s)[220] should cluster, and ideally there should be no other clusters [710]of noticeable size focused on those same objects[220]. Multiple clusters[710] can be due to sensor error or uncertainty, sensors from different angles with different views of an object[220], deliberate injection of false data or obscuring of objects, and so on. In most embodiments, when there are multiple output clusters of comparable size rather than a single large one, an operator alert[1060] will be thrown. This would suggest uncertainty of object identification and / or a successful attempt at evading surveillance.

Some embodiments will use a type of cluster analysis based on building a lattice[705] of frequent itemsets[710] as described in U.S. Pat. 8135711 B2. The approach described there was meant to apply to static problems, where the current work applies to a continuous stream of sensor[100] observations[130]. The underlying algorithms used, such as calculating the lattice[705] of itemsets[710], whether incremental or repeatedly applied, will be described in terms of iterations. The method of constructing a fence[715] in the lattice[705] is extended here for the purposes of handling differences and / or anomalies in sensor outputs[135] as well as differences in observation[130] areas.

The process of computing itemsets[710] can be thought of as the re-ordering of rows and columns in an initial sensor[100] X feature[522] matrix[720] so as to expose blocks of features[522] shared by a group of sensors[100], as in the reordered matrix[725]. Here, the features[522] are associated with events[505] in some way, and may simply be attributes that can appear in events[505], for example. In order to be itemsets[710], these blocks must be maximal. An itemset[710] is the largest set of features[522] shared by a group of sensors[100], and that block must contain all the sensors[100] sharing those features[522]. No one re-ordering can in general show all possible blocks. This is because the set of all itemsets[710] that can be derived from the matrix[720] has a deeper structure.

The set of all itemsets[710] form a lattice[705]. A lattice[705] consists of a TOP[730] element, and a BOT[735] (or bottom) element, which function as the least itemset[710] and greatest itemset[710] respectively. The itemsets[710] are related in a partial order. The order between a pair of itemsets[710] is defined via a subset relation on the sets of sensors[100] included in each of the itemsets[710]. This means that as one moves down through the lattice[705], child itemsets[710] represent both fewer sensors[100] and a larger number of features[522] as compared to their parents. This property is important for the construction of the fence[715], as described in U.S. Pat. 8135711 B2. It is also important for the form of the objective function used to score possible fences[715], as will be discussed below.

The fence[715] is a device used to determine an approximation of the best overall explanation of the data[2000], meaning that it does not just pick the largest, or highest scoring / highest frequency itemsets[710], but rather a set of several itemsets[710] that work together, as measured by maximizing an objective function. This function applies to a proposed fence[715] and is in general constructed so that the score is increased when more sensors[100] appear in some member itemset[710] of the fence[715]. Different embodiments may opt to use different approaches, including but not limited to: increasing the score for itemsets[710] containing a set of features[522] consistent with known classes of objects[220] (particularly objects[220] that are known or highly suspected to be present in the scene[405]), increasing the score for a fence[715] that contains itemsets[710] that group together features[522] with derived properties, such as compatible position and velocity that might not be represented directly in the feature[522] set.

Certain embodiments may choose to implement strategies such as penalizing a possible fence[715] if it changes significantly from the prior iteration. The purpose is not to disallow sudden changes, as these may represent important anomalies or errors in classification of objects[220] in the scene[405] that are exposed over time. Rather, it is a method for increasing the accuracy of the objective function by preferring stable interpretations of the scene[405] over time. The objective function is constructed to measure the consistency of the itemsets[710] in the fence[715] with some set of external constraints describing the real world. It is intended to pick a fence[715] that places the largest number of features[522] in consistent itemsets[710] (in effect explaining those features[522] in the data). The fence[715] construction approach from U.S. Pat. 8135711 B2 is designed to help protect from overfitting (i.e. picking itemsets[710] with a smaller number of sensors / features[522], which can match arbitrary and coincidental arrangements of sensors / features[522]). The current method builds on this protection by including an area[745] factor to the objective function (i.e. number of items multiplied by number of features[522]), which is basically pushing the fence[715] to be higher in the lattice[705].

Ideally, all sensors[100] would produce consistent readings, and there would be only one itemset[710] needed to describe the dataset[2000]. However, even before considering the impact of actual errors, as previously noted, significant variation is introduced when sensors[100] have different observational fields[150], when different aspects of objects[220] are revealed from different directions, different sensor[100] types produce different outputs[135], and when different sensor[100] types measure the same features[522] differently. Each of these cases will show up in a characteristic way in the lattice[705].

For example, features[522] associated with (parts of) observational fields[150] that do not overlap should show up in distinct itemsets[710] that do not contain features[522] from other areas[745], for example like the specific itemset[710] labelled[740] versus the other itemsets[710] in the diagram. Similarly, we would expect sensors[100] with different feature[522] sets to be grouped into distinct itemsets[710]. When sensors[100] disagree, we would expect to see a construction like the area[745] in the diagram, where an itemset[710] and one or more of its children appear in the fence[715]. When the fence[715] changes in a significant way between iterations (for example if the number of itemsets[710] in the fence[715] changes), this may mean that differences have crept in because of the changing positions of the sensors[100], or because of changing conditions in the scene[405], or it may mean that some sensors[100] now perceive that an object[220] was actually two distinct objects[220] blended together and can now distinguish them. Most incremental changes due to such factors will be small, and we expect a gradual transition, meaning that some sensors[100] will start moving to other itemsets[710], and then a few more over time. It is when there are large changes, i.e. a large itemset[710] suddenly splits in two, or larger itemsets[710] suddenly appear and disappear, that a real anomaly has likely been captured.

The evaluation of these changes depends on a number of factors, such as the positions and motions of sensors[100], the known trajectories[205] of objects[220] in the scene[405], etc. For the purposes of the method, analysis of changes in the fence[715] provides a method for detection of anomalies and suspicious elements in the system’s[10] understanding of the scene[405].

The fence[715] mechanism can also be used to improve implementation efficiencies. The method for computing the fence[715] works in a top-down manner and does not in general require looking farther down the lattics than the children of the itemsets[710] chosen for the fence[715]. This means that itemsets[710] further down the lattice[705] need not be constructed. In practice, the vast majority of itemsets[710] will occur at a lower level than the fence[715], so a significant amount of work can be bypassed if a level-wise algorithm is used. Changes in the fence[715] can be used as a mechanism for triggering recomputation in other parts of the system[10], meaning that the system[10] can work on maintaining local properties of a scene (such as updating the position[400] of known objects[220] rather than reclassifying the whole scene[405]) and run more expensive operations only when there are larger changes in the fence[715].

### Mascots [900] and Handling of Social Media

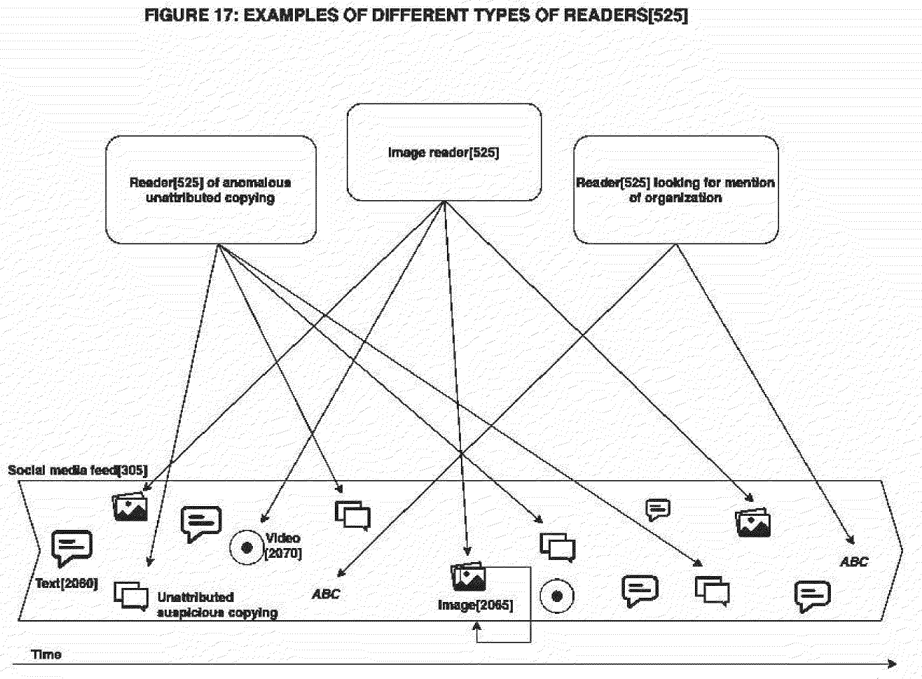

In most embodiments, complex, multimedia raw data sources[800] such as social media will generally have an arbitrary number of readers[525] of different kinds, each of which attempts to extract a particular kind of signal, and hence is the logical equivalent of multiple sensors [100]. This is depicted in FIG. 17. For example, photographs[2065] from the scene[405] that are posted on social media after a terrorist attack[6000] might be analyzed separately from textual data[2060] from posts[510] made within or near the area[405] in question, which might in turn be separate from the text[2060] in posts[510] made far away from the scene[405], which would also be separate from statistical, SNA, or other structural analysis of the posts[510].

Some readers[525] might be very logically simple, but detect very important, potentially sparse signals. For example, a reader[525] of Facebook or Twitter might only search for very specific insignia of a terrorist or other criminal organization. It might only emit a code for the specific insignia found, along with the usual metadata, including but not limited to, the name of the user[1000] who posted it, the time[3010], and the post[510] title if relevant. This is depicted in FIG. 17.

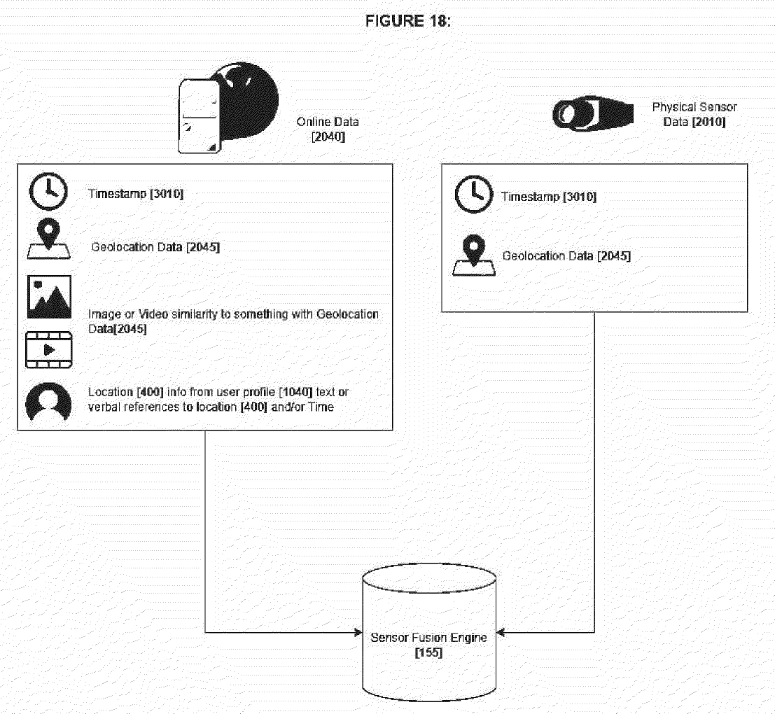

However a given embodiment chooses to extract data from social media[2040] or other similar raw online data sources[800], the problem of fusing cyberspace data[2040] with physical real world data must be addressed. Almost all embodiments will avail themselves of any geolocation information[2045] available from any object posted to any kind of online application including but not limited to social media, whether it is attached to a post[510] or an image[2065] or video[2070]. This is the best case, since coordinates can be matched up exactly with those from physical sensors[2200]. Unfortunately, such data[2000] will not always be available. Therefore, most embodiments will also accept a textual description[2060] of location[400] and time in a post[510]. This may be a literal time, or a reference to an event[505] that is unique within a sliding window of time[3000] and space set by the system configuration[125]. For example, “I was a block away from the oil depot when it exploded and I saw <X>. ", may seem ambiguous, but if it is posted to an online group whose profile indicates a linkage to a real world region (e.g. Lviv oblast in Ukraine), and there is an event[515] known (or discovered in a specified trailing window[3000] subsequently) that corresponds to an oil depot exploding in that region, the post[510] itself and any thread in which it was a part will be considered as related to the event[515] in question; most embodiments will employ a topic change detection method of their choosing to truncate threads (on threaded platforms) that extend beyond a certain time window[3000]. Many embodiments will choose to similarly bind data[2025] based on the location[400] profile of either just the individual user[1000] who made the post, or on a preponderance of user location[400] profiles for users[1000] who participated in the thread. Note that most embodiments will accept user profile location[2045] information not just from the avatar app[620] but also from any identifiable user profile[1040] data associated with that user[1000]. In the event of conflicting location[400] information, most embodiments will prefer more recent data[1040] to older data[1040] since the user[1000] may have moved default locations[400]. This scenario is summarized in FIG. 18.

Some embodiments will use machine learning or other computationally similar techniques to identify any of the images[2065], videos[2070], and textual[2060] or verbal descriptions that appear online, and appear to be very similar — or actually identical — to data items[2000] that associated with a prior instance of the same type of incident[570]. Most of these embodiments will choose to place time limits, especially on any post made before the event[570] occurred or literal seconds after it to posts[510] made weeks or more later. Some embodiments may not opt for cutoffs but rather assess the probability of a relationship to the event[570] according to a distribution of their choosing. Almost all such embodiments will perform searches looking for copies of the data item[2000] in question posted in the past -or at least clearly prior to the event[570] in question. This is advisable both as a check for disinformation as well as to simply prevent error.

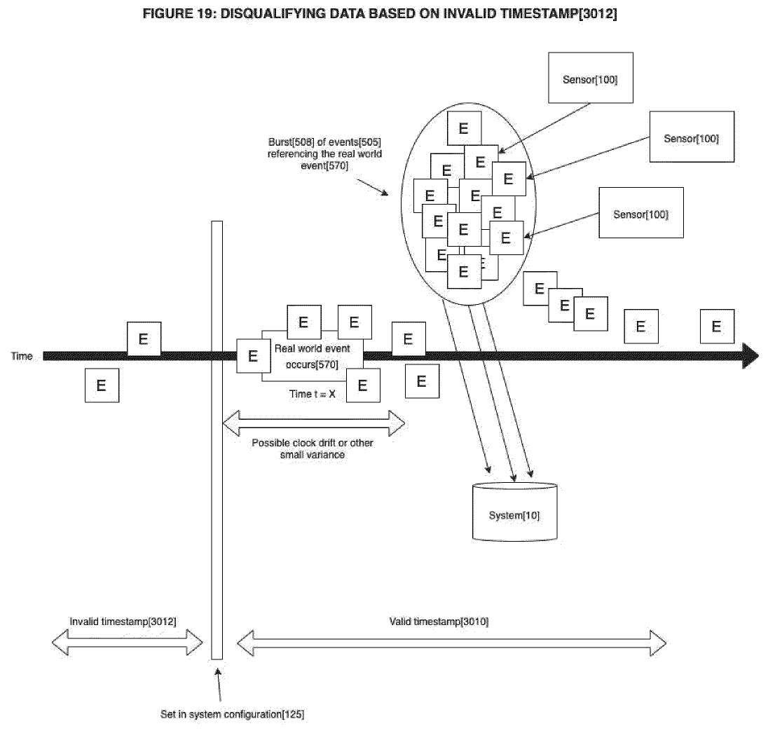

FIG. 19 depicts a significant incident[570] such as a large explosion in an urban area that occurs at time X. In its aftermath, a burst[508] (as defined in U.S. Pat. 9,569,729) of events[505] should be expected. If the incident[570] is a point in time one (as opposed to, for example, a number of explosions within a bounded window of time and space), the quantity of events[505] can be expected to fall off after the burst[508] according to the distributions that have been observed for other incidents[570] of the same type.

Somewhat less obviously, some events[505] can be expected to arrive concurrent to the point in time (or initiation of) the incident[570]. A number of diverse factors can cause this to occur. These include, but are not limited to the following:
Clock drift or manipulation on computer or other electronic systems.
A nearby and / or highly sensitive sensor [100] detects the incident[570] slightly before the incident[570] is detectable generally, or has occurred.
A combination of system sensors [100] and other components[535] has inferred that an incident[570] of a certain kind is likely to occur in a specific location and timeframe.

Thus, almost all embodiments will prefer to allow some leeway with respect to these very early events[505]. This will be expressed in the system configuration[125] in most embodiments, and will often be set independently for each incident[570] category. Some embodiments may use a simple lookback period, while others may prefer a more sophisticated approach that considers the shape of the burst[508] and the overall expected distribution of events[505] over time.

In almost all embodiments, events[505] that arrive prior to the system-designated cutoff point for being “too early” will be assigned an invalid timestamp[3012] and will be treated as invalid. Furthermore, the users[1000] or other sensors [100] responsible for these “too early” events[505] will be flagged as suspicious[1002] in most embodiments; note that in the case of a non-human human sensor [100], a label of “suspicious"[1002] is still possible. This can occur for real-world reasons that include but are not limited to devices[2200] captured by an adversary, devices[2200] hacked, altered, distorted, or jammed by an adversary, and various kinds of organic malfunctions and errors.

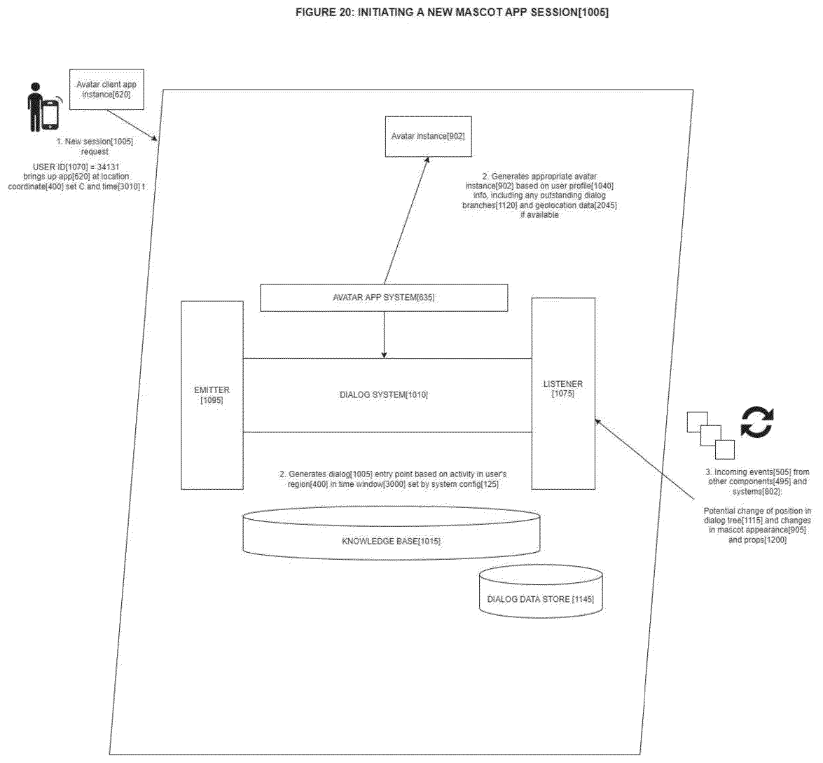

Human sensor information[2010] will be collected in a preferred embodiment by an dynamically updating dialog system[1010] with an avatar[900] front-end that will be presented to users[1000] via an app[620], most often but not necessarily a mobile one. As depicted in FIG. 20, in a default embodiment when a user[1000] invokes the app[620], the app client[622] transmits the user’s[1000] system unique ID (or NULL if a new or unrecognized user[1000]), his coordinates[700], and the timestamp[3010] at which the user[1000] invoked the app[620]. From this information and incoming events[505] within a bounded region, the system[1010] will assess the best entry point[1160] in the dialog tree[1115] for the user[1000]. In many cases this will be the top-level or more generic entry point[1160] of "what did you see?’’ However, if an incident[570] has been detected within the bounded region[405], for efficiency’s sake most embodiments will prefer to start at a lower entry point[1160], for example, "did you actually see the explosion?”. Most embodiments will choose to only have a limited lookback period[3000]; events[505] from the region prior to a significant burst[508] are likely to be discarded.

The bounds and shape of the bounding region[405] may be specified differently in different embodiments. In some embodiments, it may be a global configuration parameter, for example expressing a radius in kilometers. In other embodiments, it may be incident-type[570] specific. In still other embodiments, the bounds[405] may be irregular and correspond to geographic features, for example to correspond to a deep valley.

In most embodiments, any aspect of the avatar’s[900] appearance or behavior can change according to updates[3015] received as can the user’s[1000] position in the dialog tree[1115] until the end of the dialog session[1005]. Different embodiments may opt for different timeout strategies. However, as noted elsewhere, almost all embodiments will allow either the user[1000] or the system[1010] to pick the dialog session[1005] up at a later — or even much later — point, as determined by the system configuration[125].

### Dynamically Updating Dialog System [1010]

Although dialog systems[1010] are in common use, especially in customer service contexts, such systems[1010] operate on the basis of a dialog tree[1115] which has as many branches[1120] as are needed to deal with the reasonably common things that users[1000] will want to say and do. The number of such branches[1120] is bounded by both the complexity and very static nature of the domain[1300]. For example, a microwave oven can only malfunction or break in so many ways commonly. These ways can be easily broken down into high level categories[3030] such as “no power”, “blinking error light,” etc. They may change somewhat with the release of a new model, but not that much; the possibilities for true novelty are limited and of true emergency[515] non-existent. The resulting changes to the dialog system[1010] configuration will occur in a standard software upgrade model. Furthermore, there is no reason to believe that there will be large, simultaneous clusters of microwave ovens all independently failing in the same short timeframe.

By contrast, in an emergency[515] or similar situation, the very opposite cases hold true:
1. The exact nature of an emergency or incident[570] may not be initially knowable to any given user[1000] - or at all. Multiple explanations can often potentially apply based on limited initial information[2000].
2. Significant novelty is a real possibility - “technical surprise,” as the military refers to this;
3. Unlike customers[1000] calling in about a broken appliance who may be somewhat irritable, users[1000] in an emergency scenario may be panicked, hysterical, or otherwise behaving in an unusual fashion.
4. Large numbers of users[1000] will “call in” within a very short period of time in an emergency situation. This means that a lot of information[2000] is arriving from numerous human sensors[1000] during roughly the same time period
5. The dialog system[1010] wants to collect as much information[2000] from as many different human sensors[1000] as possible. That is its main purpose. Much of the information collected[2000] will be duplicative, and much of it may be inaccurate in some way, but gathering more raw intelligence[2000] is always preferable exactly because of the fraction that won’t be duplicative and will be accurate. Furthermore, there are multiple motivations to collect as much data[2000] as possible, including to assess the reliability of the individual human sensors[1000].
6. In the broken appliance scenario[575], the dialog system[1010] is presumed to hand over to a human operator[1050] if the caller insists, or has too much difficulty, but with potentially large numbers of human sensors[1000] trying to connect at more or less the same time, as a practical matter, the vast majority of these users[1000] cannot be handed over to a human operator[1000] since there would not be nearly enough of them.
7. While each microwave oven breakdown is an independent event - in other words, which branches[1120] of the dialog tree[1115] will be traversed depends only on what the caller says
   in an emergency scenario, incoming data from other sources (other users[1000], other sensors [100], and / or other data sources[800]) can force a change from one branch[1120] of the dialog tree[1115] to another. The most straightforward example of this is when the type of incident[570] is first assumed to be an instance of Type A, and so the user[1000] is sent down that branch[1120] of the dialog tree[1115], but in the course of the dialog[1005] it is discovered that in fact it is an instance of Type B. This will then require the user[1000] to provide any additional responses[3055] that may be needed for a Type B scenario[575].

As a result of these significant differences, existing dialog system[1010] approaches are not suitable for use in the system[10] described in this application. The main class of exception to this involves generic dialog tree branches[1120] which include standard fallback strategies for when user[1000] input is not interpretable, or the exchange of standard closing and initiating pleasantries such as “how are you today?.

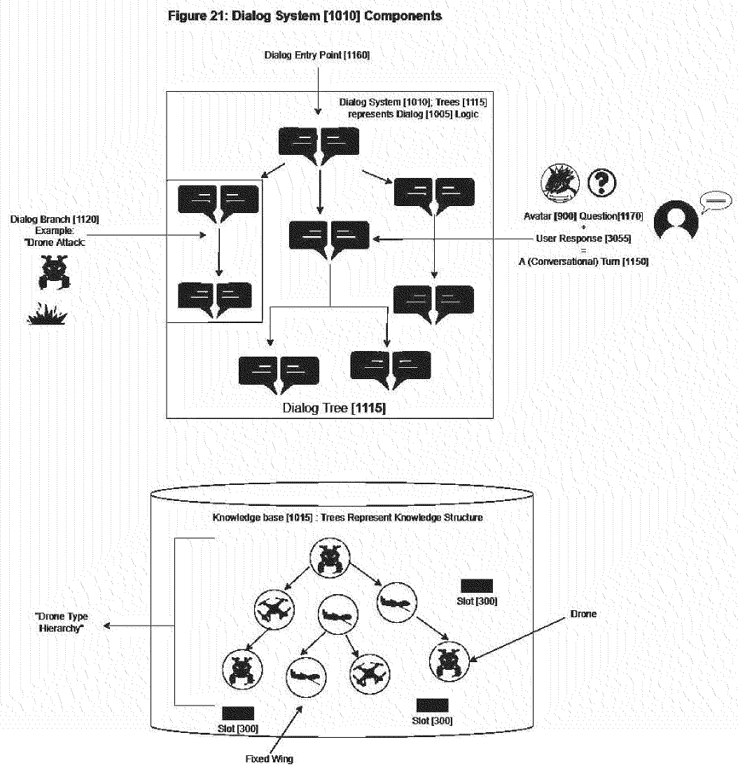

As depicted in FIG. 21, the dialog system[1010] contains a dialog tree[1115] with an arbitrary number of branches[1120]. Other than special purpose branches[1120], which are discussed later in this section, branches[1120] correspond to topics, in this case different types of incidents[570]. For example, “drone attack” might be a branch[1120] that would in turn correspond to knowledge stored in an underlying knowledge management system[1015]; different embodiments may opt to use different ones. Branches[1120] have at least one entry point[1160], for example in the case of a drone[145] attack, one entry point might be “why do you think it was a drone?” if a user[1000] asserts that an explosion was the result of a drone[145] attack. Another entry point might be “what kind of drone was it?” in the event that the user[1000] is known (or believed) to have appropriate expertise or a determined sophistication level[6010].

The combination of a dialog system question[1170] and the user response[3055] is generally known as a conversational turn - or just a turn[1150]. The dialog session[1005] is defined to be the set of turns[1150]. Most embodiments will allow for the same logical dialog session[1005] to be stopped and resumed up to some fixed number of times, during a window of time determined by a configuration parameter[125]. In most of these embodiments, either the system[1010] or the user[1000] may initiate the resumption of the dialog session[1005], for example when new information[2000] has emerged or to check or provide some kind of follow up information.

### Dynamic Updating [1105] Mechanisms

Most embodiments will prefer to implement the following modifications to standard dialog systems[1010]:

Dialog system server[600] listens for update events[3015] that can partially or completely change both the position of the user[1000] in the dialog tree[1115] and / or the dialog tree[1115] itself, including for other users[1000]. Such changes include, but are not limited to: a) shifting the dialog session[1005] to a different existing branch[1120] midstream if pursuing the existing branch[1120] to completion no longer seems worthwhile given newly arrived information[2000], b) cause a request[3035] to be issued to the user[1000], such as to leave the scene[405] immediately, c) insert a new question[1170] or generate a new dialog branch[1120] on the fly based on the newly arrived information[2000], d) reset the user’s[1000] position to an earlier point in the branch[1120], and e) cause the existing branch[1120] to terminate prematurely, in the event that the user information[2000] is deemed no longer relevant altogether. Different embodiments may opt to use different mechanisms to achieve c). These mechanisms include, but are not limited to: allowing human analysts[1050] to manually insert questions[1170] or new dialog logic[1175], passing through questions asked by trusted users[1000] on the scene[405], and any type of machine learning approach based on comparing the set of currently incoming data[2000] to prior incidents[570].

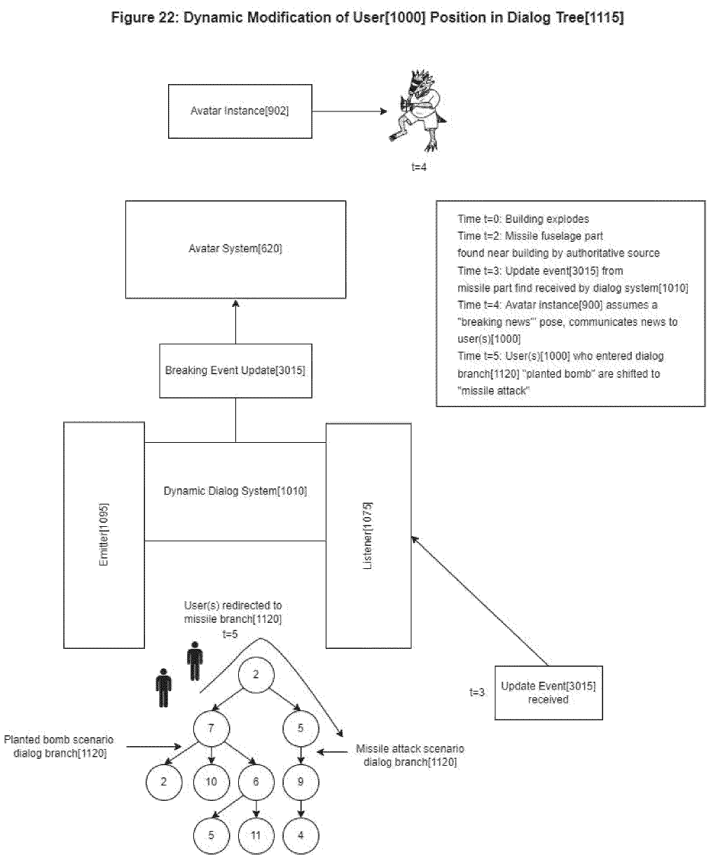

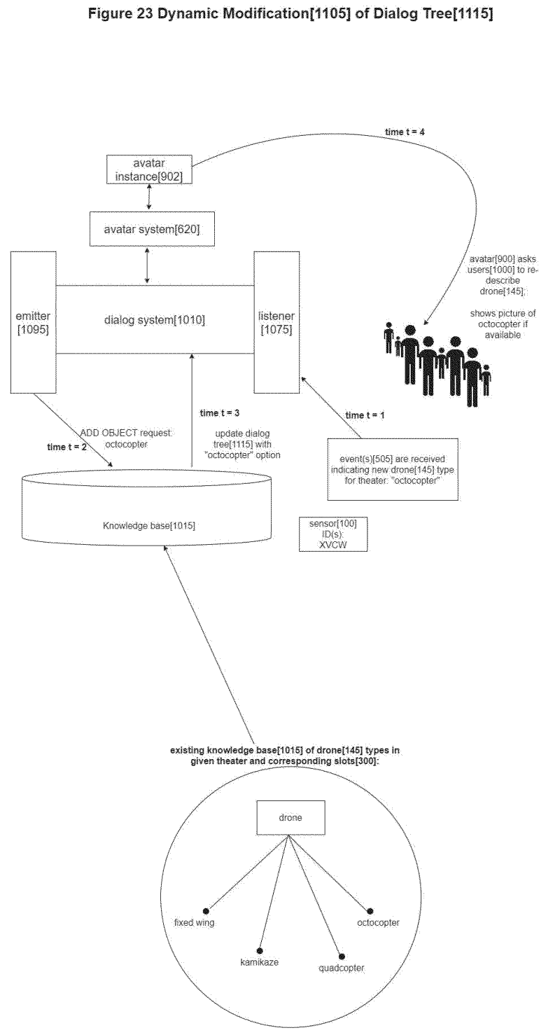

FIG. 22 illustrates a) using a real world scenario in which the system[1010] has originally defaulted to an incident[570] type involving a planted bomb, but then evidence is posted in an update event[3015] and received by the dialog system’s listener[1075] that it was in fact a missile attack[6000] being discovered. In this case, any users[1000] who had started down — or in many embodiments, also completed — the dialog branch[1120] for “planted bomb” will now be redirected to the one for “missile attack”; if the user[1000] had already ended the dialog session[1005], the avatar app[620] will send a message to the user [100] to try to reinitiate the dialog session[1005] to the now-appropriate branch[1120]. In most embodiments, if there are any duplicate questions[1170] that are inside these branches[1120] rather than above them in the tree[1115], the question[1170] will be re-asked because the surrounding context has changed. The avatar instance[902] in most embodiments will adopt one of the “breaking news” poses provided by the system library[1080] and likewise use one of the canned dialogs[1005] to inform the user[1000] that there has been a material update to the situation. FIG. 23 illustrates c) above. In this example, one or more sensor [100] events[505] indicate that there is a new or unexpected type of drone[145] in a given location. The dialog system listener[1075] receives these events[505] and its emitter[1095] posts a message[1085] requesting the knowledge base[1015] to add a new subclass of drone[145] for “octocopter”; the corresponding update must also be made in the appropriate branch(es)[1120] of the dialog system[1010]. (Note that many embodiments will have a controller[500] or analytic component[520] to determine whether or not the novel information[2000] is actually real, or whether it is coordinated disinformation or something else that is not valid.) At this point, users[1000] who have described the drone[145] in question, or are in the process of doing so, will be asked whatever additional questions[1170] are now possible given the addition of “octocopter”. Some embodiments, for example, may allow trusted users[1000] with appropriate permissions to specify new questions[1170] on the fly; almost all embodiments will allow human analysts[1050] to do so.

Update events[3015] have a variety of types in most embodiments. Almost all embodiments will support non-urgent update events[3015]; most embodiments will provide both manual and programmatic methods to dynamically change the urgency of a particular kind or sender of update event[3015] (in the case where a given sensor [100] or class of sensors [100] misbehaves). Common event update[3015] types include, but are not limited to:
Assertion of incident[570] type / Change of assertion;
Evidence that suggests probability of a specific incident[570] type;
Filling of a slot[300];
Updating of a slot[300];
End of incident[570]
Action request[3035] to user(s)[1000];
Broadcast[3040] informational message to users[1000];

Most embodiments will avail themselves of a mechanism to prevent race conditions, or the situation in which there are many rapid contradictory update events[3015] as to which emergency type[515] to use. Such mechanisms may simply block any action based upon such update events[3015] after a certain threshold level within a pre-specified time window[3000], and / or may push users[1000] to the generic information solicitation or failover branch[1125].7

Partial invalidation of data[2000] from an already at least partially traversed branch[1120]. When a user[1000] is shunted to a different dialog branch[1120] after having already provided some data[2000], in most embodiments this data[2000] will not be discarded. For one thing, it is always possible that the user[1000] will end up being redirected back to this branch[1120] as further update events[3015] arrive. For another, the accuracy of any information[2000] provided by the user[1000] can still be compared to actual reality once the dust has settled. Additionally, some of the data[2000] may be relevant to questions[1170] that will be asked in other dialog branches[1120]. (Note that most embodiments will implement their preferred version of the standard approach of assessing accuracy level[6017] according to the lowest-level / most specific slot[300] that is considered to be filled under its logic. Any reasonable accepted method in this regard may be used.)

However, because some of the questions[1170] in a particular branch[1120] may be considered “leading” (in a courtroom sense) — specifically, responsive to slots[300] that may be invalidated by a change in the categorization[3030] of the incident[570] scenario — most embodiments allow for the full or partial invalidation of such user responses[3055]. For example, if the avatar[902] asked users[1000] to tell them about the purple van parked at the corner and it is later discovered that there was no purple van, any user responses[3055] specifically about the non-existent van could be invalidated. Some embodiments will invalidate the response[3055] with respect to raw data[2000] about the incident[570] while others will also invalidate it as far as user[1000] reliability assessment as well, since it suggests that the user[1000] can be led into making false statements. In some embodiments, users[1000] who offer specific information that has since been invalidated by an authoritative source[5015] will be shifted to a different branch[1120] of the dialog tree[1115], the deception detect one. In this new branch[1120], the user[1000] would be asked where they heard or why they believed the invalidated piece of information.

Many embodiments will also choose to concern themselves with information[2000] that was only partially incorrect or misleading rather than simply false. Depending upon the embodiment, this could be confounding an instance of one subclass of a given class with that of another subclass (e.g. tank vs armored car,) a subclass with a term that connotes the superclass (e.g. moving van with car), or the reverse case. For example, if new information[2000] “orange moving van” refines an older piece of information[2000], “orange car”, information[2000] provided on any dialog branches[1120] which related to the broad type of the “orange car” will now be invalidated in many embodiments. This is because the probability of other pieces of information[2000] being inaccurate goes up if it is known that at least one piece was inaccurate.

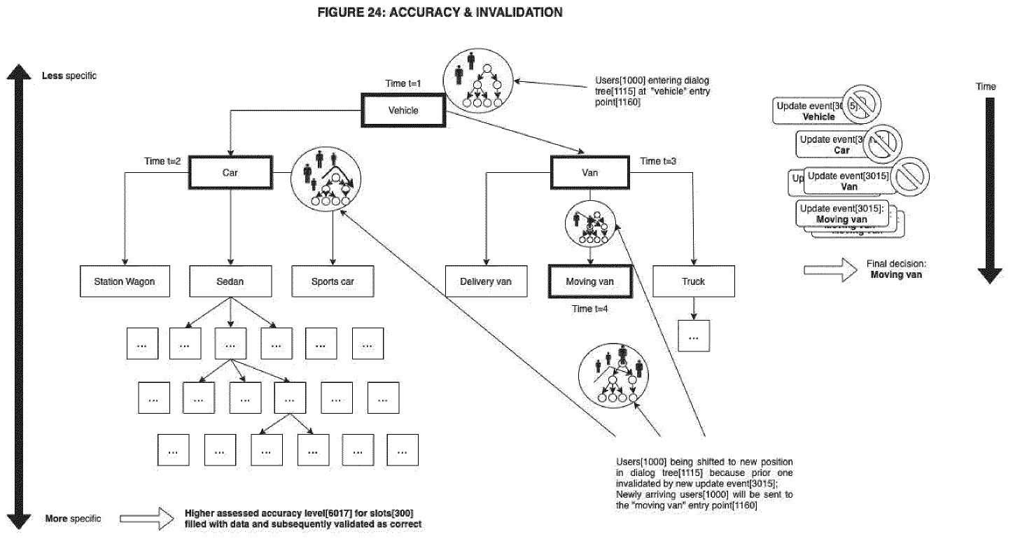

FIG. 24 depicts a scenario in which different sensors [100] initially disagree on the type of a vehicle being tracked but eventually determine that the correct type is “moving van” after going through the more generic “vehicle” and “van” as well as “(passenger) car.” Each such update event[3015] will cause any users[1000] who had entered at the now-wrong (or now-non-optimal) entry point[1160] to be shifted to the now-correct one of “moving van.” Newly-arriving users[1000] will now enter at this entry point[1115]. In other words, these users[1000] will be asked by the avatar[900] questions[1170] such as “Do you remember where the moving van was parked?”

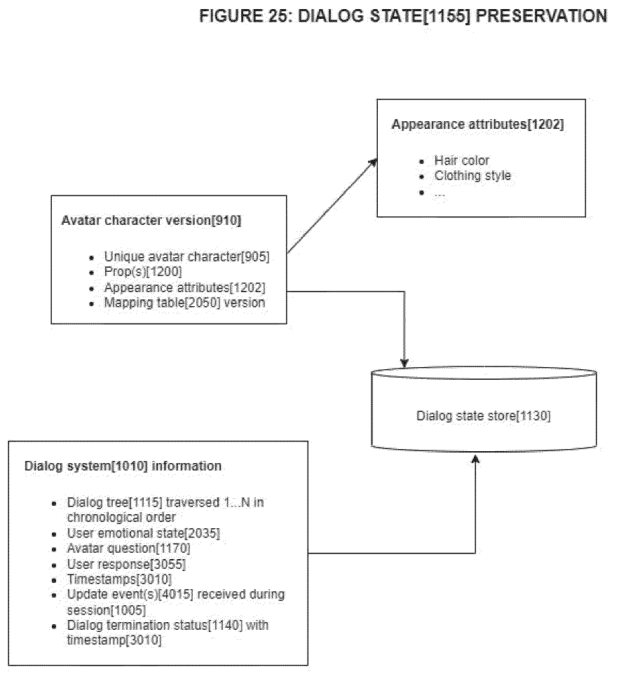

Dialog state[1155] will be preserved for an extended period, enabling the dialog[1005] to be continued at a much later point in time (and not just for use by ML, or system performance analysis). The aging out or “time to maintain” parameter[1090] will be determined by most embodiments according to the type of incident[570] which will be set by a human analyst[1050] with appropriate permissions. This is because good witness information[2000] may be valuable for months or longer. Most embodiments will enable configuration options that dictate how long such state data[1155] will be saved in the dialog state store[1130]; some embodiments may offer different time out parameters depending on the category[3030] of the incident[570]. FIG. 25 depicts the stored data[1155] in a default embodiment. These are:
0. Avatar character[905] and version[910] including territory[1300]
1. Branch(es)[1120] at least partially traversed and their versions[910] in order of actual traversal and timestamp[3010] at each turn; in most embodiments this will include all branches[1120], including any “special” ones such as the deception branch[1135] or the generic failover one[1125].
2. User response[3055] at each turn in each branch[1120], including but not limited to, content posted (text[2060], images[2065], video[2070], sound[2075]) and derived emotional state[2035]
3. Dialog termination status[1140]. A default set of termination statuses is: completed successfully, fall off - user[1000] disappeared for no clear reason, interruption (user[1000] likely left the scene[405] in a hurry or was injured / killed, suspension (user[1000] indicated he/she intends to resume later,) and termination by system[1010].

Fallback to generic questions[1170] in the case of technical surprise or other novelty. In the event that it is not possible for the system[1010] to select a stable category[3030] for the incident[570] and hence no dialog branch[1120], in most embodiments a generic dialog branch[1120] will be provided that asks and records basic questions[1170] only such as “can you describe what you saw?”, “when did this occur?”.

Specificity[6005] / information value[5000]-based prioritization. Users[1000] who provide data[2000] that is highly specific and / or has a high degree of information value[5000] (as defined U.S. Pat. 9,569,729) that appears consistent with what is being reported by other sensors [100] at the time, and which subsequently may be verified as fact, will be considered as especially valuable human sensors[1000] by most embodiments. Such highly specific information[2000] generally has the advantage that it can quickly be validated as at least plausible. Many such embodiments will opt to treat such users[1000] as higher priority in ways that may include, but are not limited to, assigning them priority for human operator[1050] routing, connecting them directly with more skilled analysts[1050], connecting them to human sensors[1000] who may be physically nearer to the incident[570] or have a superior vantage point on it, providing expert level dialog tree branch[1120] alternatives, and bucketing their data[2000] separately for analyst[1050] consumption.

Default user[1000] reliability assessment. Most users[1000] in most situations will not be able to provide detailed, highly specific data[2000]. This is for many reasons, including lack of relevant expertise or experience, being distracted, and not being sufficiently close to the incident[570] to directly see it. However, this does not mean that the information they do have is meaningless. Thus, most embodiments will opt to treat such raw data[2000] seriously and try to vet it appropriately -for example, trying to filter out attention seekers, crazy people and others who might provide inaccurate information. Many embodiments will deliberately insert somewhat duplicative questions[1170] into the dialog trees[1115] to check for consistency in the user’s[1000] narrative. Others will ask for user[1000] confirmation repeatedly.

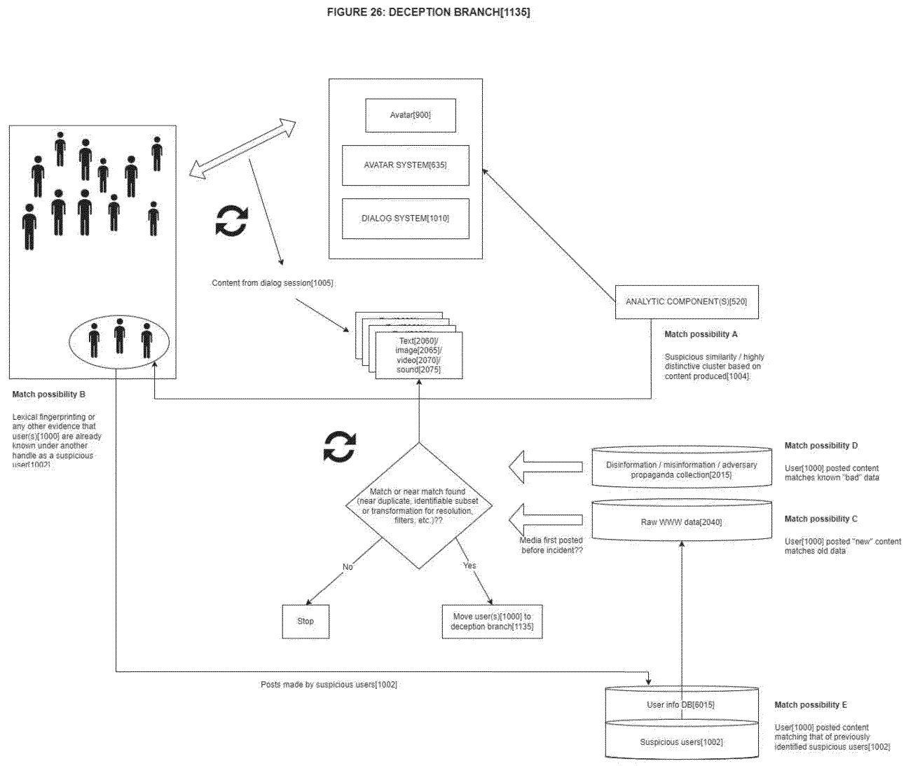

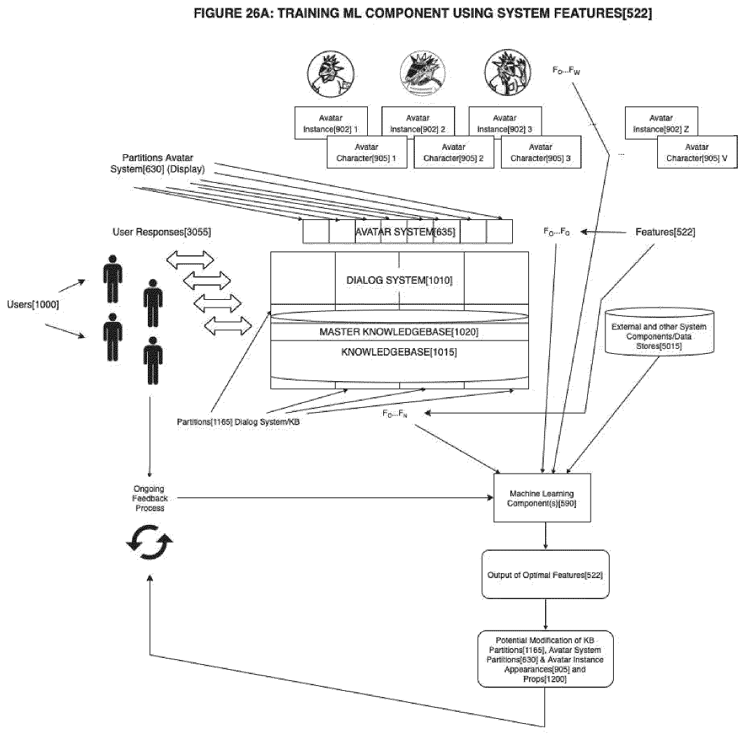

Deception detection dialog branch[1135] modification. A more dangerous threat[1100] to the goodness of crowdsourced data[2005] are those human sensors[1000] who are controlled by a state actor[1055] or other organization that wishes to sow chaos and obscure fact in the face of some kind of emergency. For this reason, most embodiments will make use of a dialog branch[1135] that is more interrogation-oriented, and will solicit information[2000] oriented towards identifying the sources of the misinformation. Different embodiments may opt for different approaches with respect to when to push a user[1000] into this branch[1135]. These include, but are not limited to:
Assessing an unusual degree of lexical similarity among either or both N untrusted / previously unknown users[1000] and / or online data sources[800] known to be under the control of an adversary (Match possibilities B) and D) from FIG. 26)
Similarly, assessing an unusual amount of agreement on specific details that do not manifest outside of the set of N untrusted users[1000] and / or adversary-controlled data sources[800]. (Match possibility A) from FIG. 26)
Assessing an unusual degree of similarity with users[1000] who have been previously flagged as suspicious. (Match possibility E) from FIG. 26)
Combination of the posting of media objects[160] that clearly predate the incident[570] in question and assertions in text[2060] and/or voice[2075] that the media object(s)[160] depict the current incident[570]. (Match possibility C from FIG. 26.) By “clearly” predate we mean that logical duplicates of these objects[160] appeared online prior to a configured time offset and/or that logical equivalents of these objects[160] exist from authoritative sources[5015] with timestamps[3010] that clearly predate the current incident[570]. Some embodiments will also allow the inclusion of data from somewhat authoritative sources[5017], and have a more complex view than “authoritative” vs “raw.” (As elsewhere, “logical equivalent” includes, but is not limited to: actual hash equivalents, near duplicates, subsets, and transformations to adjust for resolution and filters.)

Detection and handling of a broad emotional spectrum in both text[2060] and voice[2075]. Most embodiments will seek to identify heightened emotional states[2035] on the part of individual users[1000] so that they can cause the avatar’s[900] appearance, behavior, message characteristics and if appropriate tone of voice to change accordingly, and so that they can do a better job of accurately interpreting user input[2000]. Additionally, many embodiments will use ML techniques of their choice to determine how well different mappings of avatar[900] feature changes to user[1000] emotional state[2035] actually work. In most embodiments, this will be done using machine learning methods, including but not limited to classification of selected speech, lexical and / or facial features, or deep learning. While acoustic features such as mel-frequency cepstral coefficients (MFCCs), linear prediction cepstral coefficients (LPCC), short-time energy, fundamental frequency (F0), formants, etc. are most widely used², certain lexical features can be used in cases where speech is not part of the embodiment³.

### Mascots 900

By contrast, the chatbot avatars[900] used as the system[10] front-end in most embodiments are similar to those described in U.S. Pat. Application 16/576736 and U.S. Pat. Application 20220164643, but with behavioral mappings[2050] suitable for the broad range of user[1000] emotional states[2035] is likely to be encountered.

Specifically, the exact behavior and appearance of the mascot[900] will vary not only by embodiment but also according to parameters including, but not limited to, the local demographics[2030], local culture and the type(s) of scenarios[575] that the particular instance of a mascot[902] will be geared towards. In most embodiments, the avatar[900]'s body language and facial expression will be appropriate for the type of data[2000] being communicated by the user[1000] according to the norms of the local culture, as well as incoming data from other users[1000]. For example, news that people have been killed or injured will be met with a sorrowful expression and posture. Conversely good news, for example that no one was seriously injured, will be met with a happy or relieved expression and posture.

Most embodiments will use mapping tables[2050] to enable this capability. Different attributes of user[1000] behavior observed in one or more conversational turns, either singly or in conjunction with one another are mapped to one or more features[522] that the avatar instance[902] will manifest. Most embodiments will offer variations so as to make the avatar[900] seem less artificial. These attributes of user[1000] behavior will vary with what is observable given the media of communication. These include but are not limited to: user[1000] pitch of voice, amplitude of voice, facial expression, body language, sentence structure, intonation, register, lexical output, and loud talking⁴ as discussed in U.S. Pat. 9,569,729. In most embodiments, this will be done using machine learning methods, including but not limited to, classification of selected speech, lexical and / or facial features, or deep learning. The avatar[902] reactions will have a matching feature[522] set in most embodiments, however in most embodiments the avatar[902] won’t directly mirror the user state[2035], instead using a mapping mechanism[2050] for an avatar[900] response based on user emotion[2035]⁵. This is because, for example, a calming tone of voice may be a better reaction to an angry tone of voice than an angry one would be. Additionally, the optimal reaction may vary by local culture.

So as to be optimally accessible to the widest possible range of users[1000], these mascots[900] will have the best possible NLU and NLG capabilities. In most embodiments, the mascots[900] will avail themselves of both text[2060] and voice[2075] interfaces. In virtually all embodiments, the mascots[900] will also be able to post objects of different kinds, including but not limited to: pictures[2065], visualizations[2065], sound clips[2075], video[2070], choice controls so as to most effectively and efficiently solicit information[2000] from users[1000]. Because the scope of the interactions will be topically limited to a certain number of incident types[585], existing NLU and NLG techniques should be serviceable.

This is necessary for very practical scalability reasons. Any type of widespread “see something say something” campaign would suffer from scalability problems because the number of 911 or similar operators in a region is always limited; likewise for analysts[1050] assigned to read text[2060] inputted by users[1000] in any online reporting mechanism. Long delays waiting for a human to respond whether via phone or chat discourages would-be helpful citizens from making an attempt to provide information[2000]. In this way, potentially important, time critical information[2000] from human sensors[1000] could be lost or delayed.

Individual instances of these avatars[902] adapt various features[522] based on aspects of the specific user[1000] and her behavior during the interaction as well as external context factors. The adaptable features[522] include, but are not limited to: facial expression, body language, gender, age, wardrobe, accessories and props, tone of voice, linguistic register, spoken language or accent, and level of vocabulary, conceptual, and grammatical complexity. However, in most embodiments, the avatars[900] can have rules that apply to all instances, so that the “brand” or allegiance and function of the avatars[900] is very clear. For example, perhaps all avatars[900] must wear a particular armband.

In many embodiments, a set of different avatars[900] will be used with the aim of optimizing the likeability of the avatar[900] for the particular types of users[1000] who are likely to be the most common in a given “territory"[1300]. Territories[1300] may be defined by geography, presumed incident[570] or hazard type (for example, Smokey the Bear for wildfires), targeted towards specific demographic groups of users[1000], combinations of these, or any other partitioning scheme that may be considered advantageous to maximize public awareness of, and engagement with, the mascots[900]. Within their assigned territory[1300], however defined, the servers[1025] for avatars[900] of the given type will receive all system events[505]. These events[505] may be designated to be broadcast[3040] to the territory[1300], or some defined subset of it. Users[1000] who receive and respond to such broadcast events[3040] will be presented with an avatar[900] of the assigned class. Users[1000] may also contact the system[1010] - with the avatar[900] as a proxy - to report some new event[505]. In most embodiments, if a user[1000] contacts the wrong mascot[900] based on the territory[1300] definitions in place using some kind of fixed mechanism such as a social media account[615] associated with a different mascot[900], they will be redirected to an instance[902] of the correct one. This is based on the assumption that, at least in general, meaningful optimizations for the territory[1300] are reflected in the avatars[900], and so the user[1000] interacting with the “right” avatar[900] may yield better data gathering[2015] results.

Because there will generally be no clear way to partition the usage of different avatar[900] characters in order to achieve the best overall outcome — the greatest amount of good data[2000] gathered — most embodiments will provide for the versioning of both different avatar[900] designs and of the partitioning of the logical space into different avatars[900] with different assigned territories[1300]. With the versioning information, human analysts[1050] can use statistical or other methods to determine how well different partitioning strategies perform and what further adjustments to make. Many embodiments will likewise avail themselves of machine learning techniques to assess which features[522], including territory[1300] partitions[630], were effective vs. not. FIG. 26a depicts the sets of features[522] being input into a machine learning or similar component[535], the output from which in many embodiments will be used to automatically adjust system behavior.

It should be noted that there is not necessarily any mapping[2050] between the avatar[900] territories[1300] and the underlying segmentation[1165] of the knowledge bases[1015] used by the dialog system[1010]. Segmentation will generally be important to provide the best overall system[10] performance, for both the front end (avatars[900]) and the backend[627] (dialog system[1010]), but the segmentation lines may be quite different. For example, it is possible that a single avatar[900] character might work quite well for an entire country in some cases, and it would certainly enjoy stronger public recognition. However, combining dialog trees[1115] and backing knowledge bases[1015] for numerous different types of emergency[515] and other public safety scenarios[575] unsegmented over an entire country would be unlikely to lead to optimal system[10] performance because the exact segmentation[1165] will impact system[1010] performance and so is one of the features[522] that will be fed into machine learning and / or other analytic components[520].

As elsewhere noted, any system[1010] that is even implicitly rules-based tends strongly to have its number of rules monotonically increase over time. This in turn degrades both system[10] speed (because executing ever more rules, and ever more complex rules requires more time), and system performance (because experience shows that beyond a certain size and complexity of rules, human analysts[1050] start to have great difficulty in accurately understanding what the collective effect of the rules is). Nonetheless, a high level master knowledge base[1020] or other functionally equivalent mechanism, will still be used by most embodiments to efficiently and effectively enable user[1000] transitions from one dialog partition[1165] to another. Some embodiments may prefer to use ML or hybrid approaches to enable such transitions.

### Optimizing the Efficiency of User [1000] Interactions

As elsewhere noted, extracting information[2000] from users[1000] as quickly as possible is often critical from a purely practical point of view. Most embodiments will try to optimize efficiency of interaction in at least two key ways:

1. Most embodiments have more sophisticated dialog branches[1120] and/or dialog logic[1175] within a dialog branch[1120] for more sophisticated users[1000]. For example, a user[1000] who can immediately and accurately distinguish a T-72 tank at a distance from models of a similar era does not require N many turns[1150] of dialog[1005] to try to narrow down what kind of tank the user[1000] probably saw. Similarly, the use of pictures or choice menus to identify particular objects either won’t generally be necessary or efficient with a sophisticated user[1000] since such a user[1000] would already be in possession of this knowledge.

In most embodiments, sophistication level[6010] is used to slot the user[1000] into the right branch[1120] and/or conditional logic. However, especially since sophistication level[6010] may not yet be assessable for a new user[1000], almost all of these embodiments, a user[1000] who appears to demonstrate such expertise empirically will be provisionally credited with a sophistication level[6010] that corresponds to other users[1000] who are providing the same goodness of data[2000] in the context of the same type of incident[570]. Most embodiments will provide special dialog logic[1175] for this case.

To take another example, if an unknown user[1000] tells an avatar[902] that he has just seen a column of 20 T-72 tanks, the dialog logic[1175] may have the avatar[902] ask the user[1000] “why do you think these tanks are T-72’s and not T-70’s?”: If the user[1000] provides an answer that the dialog system[1010] interprets as correct, it has at least done some due diligence to try to establish the user’s[1000] expertise. But if a user[1000] provides a wrong answer[3055], an uninterpretable answer[3055] — or no answer[3055] at all — in most embodiments the user[1000] will not only not be given the benefit of the doubt, but will be considered to have provided inaccurate information[2000].

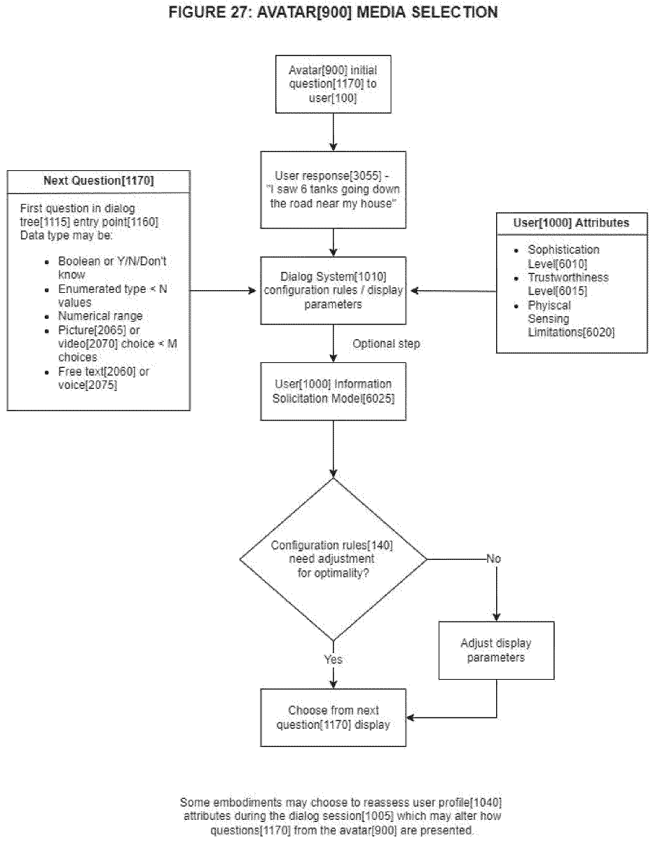

2. Generically optimizing how the avatar[900] will solicit information[2000] from users[1000] with mixed media usage in avatar[900] responses. FIG. 27 shows an example of this:

When a user[1000] arrives at the entry point[1160] to the dialog tree[1115] and is asked a question[1170] by the avatar[902] such as “what did you see?”, and the user[1000] replies that he saw 6 tanks on the road near his house, in most embodiments the dialog system[1010] will use a combination of pre-defined configuration rules and knowledge that it has in the user profile[1040] about the user[1000] to determine the best media — or combination of media — with which to respond. By default, the relevant configuration rules will be set up to avoid obvious usability problems, especially on the short format of a mobile phone. For example, if a list of possible object types from the user[1000] will be asked to choose exceeds N, only the M most probable choices for the given region[400] will be shown by default, along with a “more” or similar button. Most embodiments, in addition to considering sophistication[6010], will also consider other information[2000] that is known — or in some embodiments, inferable — about the particular user[1000]. For example, it would not be efficient to densely pack the screen with photos[2065] of similar objects if the user[1000] does not have good reading vision ability. Many embodiments will also try to adjust for the characteristics of the device and the network that the user[1000] is using during the dialog session[1005].

A default embodiment will train and use the user[1000] solicitation information model[6025] to further optimize the display choices made by the avatar system[635].

### Broadcasting [3040] & Contact Mechanisms

Most embodiments of the system[10] described here presume that the mascot characters[900] have social media accounts[615] and / or active presences on some type of online forum or dedicated application that is accessible to the general public. However, beyond that the system[10] is broadcast[3040] mechanism-agnostic. Different countries, geopolitical situations, and territories[1300] may simply demand different approaches in this regard.

These public or semi-public mascot accounts[615] can be used to solicit important information[2000] from users[1000] that has not yet been posted, to confirm existing reports, or to request clarification on existing posts[510], either from specific users[1000] who have posted relevant content, based upon geofencing, or any other criteria desired. Such solicitations[555] can be made to the individuals publicly or privately via direct messaging assuming that the platform in question supports it. Furthermore, in most embodiments, members of the public can also directly message or otherwise reference a mascot[900] proactively.

The mascots[900] can also be used within dedicated apps[620] which can provide greater flexibility in user interaction mechanisms[1035] as well as better security. Interesting real-world examples of such applications in preference to social media exist in wartime Ukraine because the government[5015] does not want to give the enemy easily collectible OSINT on the damage that they are causing.

### Failover Strategies

User attempts to engage the mascots[900] in conversations that are outside of the relevant domain[1300] would be met with the mascot[900] explaining its function, and that it doesn’t talk about other things

in other words, the standard behavior of a chatbot[1030] to either unidentified input, or to input that is recognized as being in an out of bounds category.

In most embodiments, a configurable threshold number of failures to obtain the desired information[2000] — in other words to get users[1000] to complete a dialog branch[1120] — across a number of users[1000] within the same physical area[400] within a brief interval of time[3000] would trigger a security analyst alert[1060] in most embodiments as it would likely indicate a novel scenario[575] or incident type[585] (e.g. one for which there are no dialog trees[1115] or similar specified), or else a situation inciting extreme degrees of panic and confusion. In this event, most embodiments will shift into a situation-neutral data solicitation[1065] in which very generic questions[1170] are asked, for example “Please describe what you saw and heard” rather than specific questions[1170] relating to one type or marking of drone[145] vs another.

Similarly in many embodiments, if more than a pre-specified number N of users[1000] fail at a particular turn[1150], the system[1010] will assume that there is some kind of problem associated with either/both the question[1170] that initiates turn[1150] T and/or with the users'[1000] attempts to respond to the question[1170] in a way that is interpretable by the dialog system[1010]. Different embodiments may handle this differently; options include, but are not limited to: throwing an operator alert[1060], logging an alert[1060] in a special purpose audit trail, directing the users[1000] to a help page or similar resource, or any combination of these.

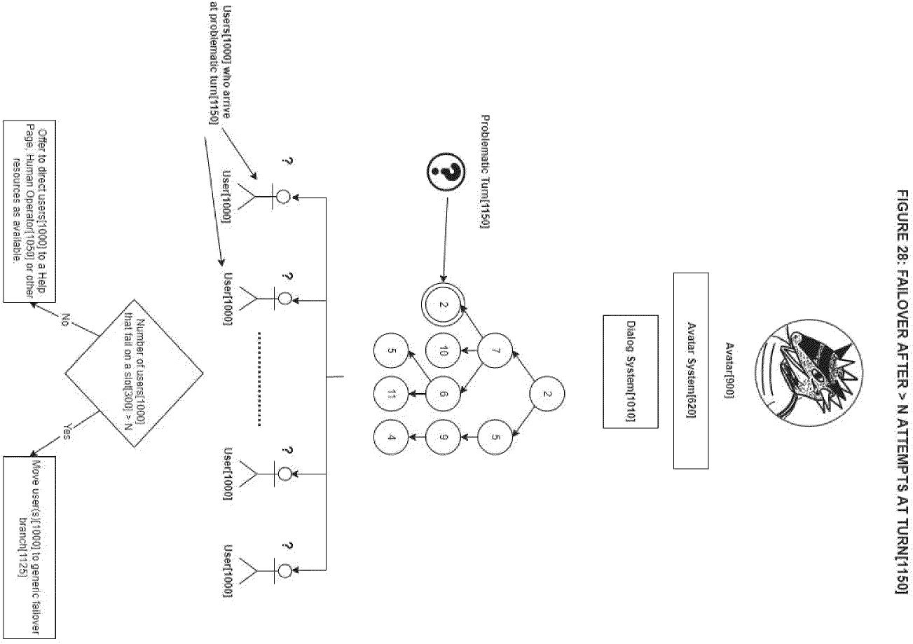

FIG. 28 illustrates the case in which a particular turn[1150] is causing user failures[990]. Different embodiments may prefer somewhat different definitions of user failure. These may include, but are not limited to: user[1000] does not respond within an unexplained (e.g. no action request to move away from the scene) pre-configured interval of time[3000] and/or shuts down avatar app[620], exceeding a pre-specified threshold of sequential dialog system[1010] failures to interpret responses[3055] from the same user[1000], evidence of user[1000] frustration (in most embodiments obtained from comparing user responses[3055] to a stored library of things like curses, requests to speak to real person) or any combination of these.

### Avatar [900] Handling of Update Events [3015]

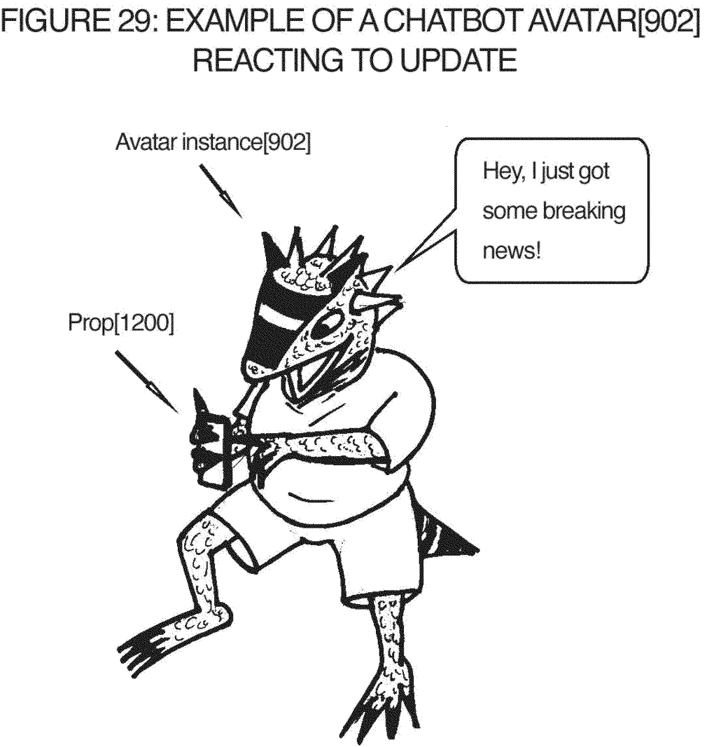

As pictured in FIG. 29, when an urgent update event[3015] arrives, the avatar[900] in most embodiments will mimic the reaction of a person who has just heard some important breaking news. For example, in some embodiments the mascot[902] may be rendered holding a cell phone[1200] that makes an urgent sounding beep; in other embodiments it might momentarily turn its head as if it is listening to something in the background. Most embodiments will choose to provide the mascot[902] with a number of different prop[1200] options such as the cell phone[1200] for purposes of variety; likewise for any context in which having other objects visible with the mascot[902] improve the ability to communicate with the user[1000]. This applies not only to props[1200] that the mascot[902] holds but also to a variety of appearance attributes[1202] that will vary by both territory[1300] and embodiment.

In most embodiments, both the urgent update event[3015] and the dialog system[1010] response to it can be configured to be automatically broadcast on all accounts controlled by the relevant mascot[900]. In most embodiments, the avatar[900] will offer an apology for the interruption and explain the breaking news event[505] that caused it. The knowledge base[1015] will come equipped with a library of canned dialog[1005] for this case.

Most embodiments will render the avatar[900] as monitoring news screens, monitors or similar to emphasize that new information[2000] is constantly streaming in, and thus prepare the user[1000] for the possibility of shifting dialog branches[1120], and likewise for the possibility that some of the dialog[1005] that has already occurred was in the end probably not useful.

### Non Substantive Dialog [1005] Content

If the threat[1100] has been terminated — for example, there was a vehicle being driven by a drunk driver who has now been apprehended — most embodiments will dynamically update the dialog[1005] with this happy information[3015] to share with the user[1000]. Depending upon the specific rules implemented in the dialog system[1010], the chatbot[1030] will either finish soliciting information[2000] from the user[1000], or terminate by thanking the user[1000] for their help.

The main motivation for conducting the additional rounds of dialog[1005] is that users[1000] would feel that they had contributed to containing a public safety risk. However, it is also the case that each dialog[1005] between an avatar[902] and a user[1000] provides an opportunity to collect more information about the user[1000] and to assess the reliability of that user[1000] as a human sensor[1000].

In addition to soliciting information from users[1000], avatars[902] can praise users[1000] for providing useful information[2000], and as appropriate, indicate what the results of that information[2000] being reported were. Dialog trees[1115] in most embodiments will also include standard dialog content that, as appropriate based on either/both what the user[1000] asks, and / or the dialog system[1010] assessment of the user’s[1000] emotional state[2035], assures the person[1000] that they are not the only person[1000] who has seen or heard X, that help is on the way, and so on, as well as the exchange of pleasantries.

In most embodiments, dialog trees[1115] may also include asking the user[1000] specific things about themselves so as to get a better idea of their reliability in reporting a specific thing, for example details about their vision, whether or not they were wearing glasses or contacts. In most embodiments, such branches[1120] can dynamically be executed to different depths, and in different orders in the dialog[1005] depending on whether the person[1000] reporting is contradicting other persons[1000] on the scene[405] or information[2000] that is considered reliable, or whether they are the first and hence only person[1000] reporting a given thing[2000], and the probable importance of the thing[2000] in question. To take the most simple example, if a given user[1000] is reporting details that are consistent with other users[1000] and sensors[100], many embodiments may choose not to query the user[1000] about his eyesight. But if this user[1000] is reporting quite different, inconsistent things[2000], an initial question[1170] may be asked. Because ongoing update events[3015] can change any of these things[2000] — for example, more people can turn up making similar reports — such modifications may continue to occur until the end of the dialog session[1005].

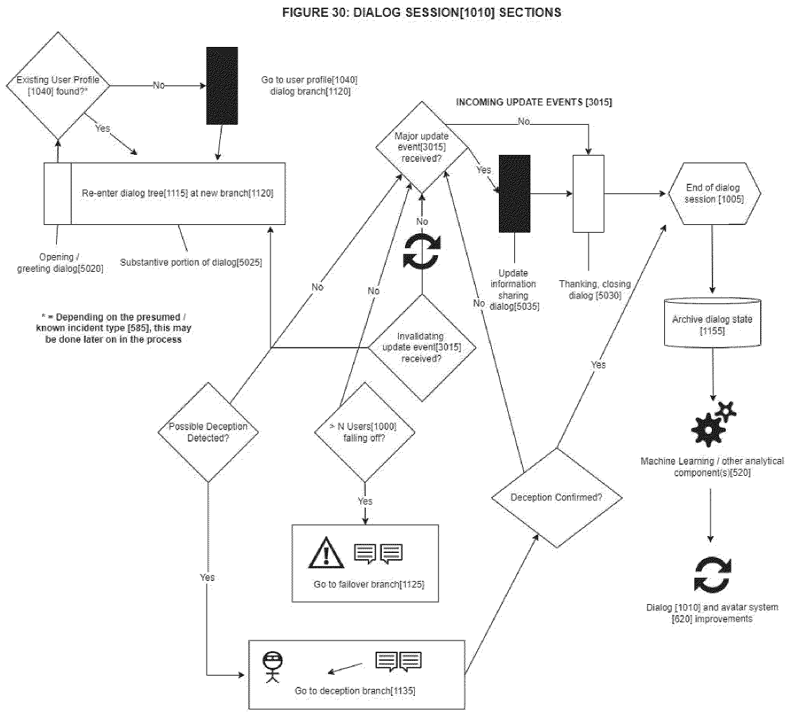

FIG. 30 depicts the different possible stages of a dialog session[1005] in a default embodiment. These are as follows:

### Generic Stages

Opening / greeting[5020]: in this stage, most embodiments will either welcome back a known user[1000] or ask a presumed new user[1000] to identify themselves. Depending on both the specific embodiment and in many embodiments, the specific type of incident[570], solicitation of full user profile information may wait for a later stage in the dialog session[1005]. This last will generally be the case if getting information about the incident[570] underway is considered especially time-critical. Substantive portion[5025]: In this stage information about the incident[570] is solicited from the user[1000] by the avatar[902].

Closing / thanks[5030]: The avatar[902] thanks the user[1000] for their help and may provide some other information such as follow-up information.

### Special Purpose Stages

User Profile[1040]: In this stage, the necessary information about the user[1000] is solicited by the avatar[902]. This will occur for new users[1000] but may also occur in other situations, for example if new user attribute fields are added to the system[1010], or if a user[1000] is in an unexpected location relative to the information in their existing profile[1040], or has suddenly gained a significant amount of new expertise.

Information sharing[5035]: In the event that a major update event[3015] is received during the active course of the dialog session[1005] — and in some embodiments, even after it or during any significant pauses — the avatar[902] will “share[5032]” it with the user[1000].

Generic Failover[1125]: A basic who, what, when, why, how dialog branch[1120] to be used when all else fails.

Deception Branch[1135]: An attempt to more closely interrogate users[1000] in cases in which there is reason for the system[1010] to believe that bad information is being deliberately provided by one or more users[1000].

### Assessing & Optimizing System Performance

Most embodiments will choose to use multiple system performance metrics[3050]. As elsewhere noted, the goal of the system[1010] is to extract as much accurate information[2000] from users[1000] as efficiently as possible. Not the most data, but the largest amount of accurate data[2000] of which each user[1000] has possession. This amount will unavoidably vary greatly by user[1000] based on numerous factors previously described. Thus failure to extract comparable levels of information[2000] across users[1000] will not be considered suitable as a valid system[1010] performance metric[3050] by most embodiments. Many embodiments may employ expected distributions in this regard. In fact, some embodiments might choose to use a high degree of uniformity of information[2000] taken from a user[1000] as a metric[3050] of poor system[10] performance.

To see why this is, consider that for someone who truly knows nothing about cars, the most accurate information they could likely provide about a particular car would very likely involve attributes[2000] such as “color”, “dirty or clean”, “new or old” and very basic type (e.g. truck vs van vs sedan vs sportscar). By contrast, someone who does know a lot about cars and got a good look would provide much more specific data[2000] such as model, make, year, special features such as tire hub caps, and perhaps the exact manufacturer name for the color. Such experts can be asked to provide information[2000] such as “dirty vs clean” but the person who knows nothing about cars cannot generally be expected to provide the expert-level information.

However, if such a person is repeatedly asked for it in different ways — for example by showing different pictures[2065] — some of the users[1000] will try to provide such information[2000] for reasons ranging from wanting to please or be helpful, to simply wanting to be done with the thing. This explains why many embodiments will include questions[1170] about the user’s[1000] level of knowledge[985] on relevant things that lie ahead on the path of the current dialog branch[1120], if that information is not already available in the user’s system profile[1040]. Such embodiments will generally adjust informational accuracy measurements accordingly, so as to avoid assessing penalties for lack of specificity[6005] in cases in which the user[1000] was simply unable to provide the desired data[2000].

Many embodiments will consider the ratio of accurate to inaccurate information[2000] collected, though most embodiments will remove users[1000] with known histories of submitting inaccurate and / or irrelevant information[2000] to the system[10], and any that are assessed to be deliberate sowers of misinformation. This is because such things — at least to the extent that they can be identified — will always occur and are not the result of any system flaw.

It should be explicitly noted that in some percentage of the cases, it may never be definitively known whether a specific piece of information[2000] was correct or not. For example, a suspect in an arson incident[570] may never be identified. Different embodiments may choose to handle this reality differently. Some embodiments may simply choose to ignore such arguably ambiguous cases. These embodiments will of necessity use at least slightly trailing measures to measure accuracy rates[6017], thus allowing for as much real-world validation of information[2000] as there is likely to be had. Other embodiments will prefer to count data[2000] absent from such final verification if there is substantial agreement among the different sensors[100]. Such embodiments may avail themselves of any sensible method of assessing such agreement.

Many embodiments will employ a metric of informational accuracy according to the how well-filled the slots[300] are which are bound to the given category/ies of incident[570]. Specifically, the slots[300] that are bound to the completed conversational rounds in the branch(es)[1120] associated with the category/ies[3030]. On the one hand, if the user[1000] fails to complete the substantive part of dialog[5025], by definition it is likely that not all desired information[2000] was gathered. But on the other hand, most embodiments will measure user[1000] fall-off rates as a separate system performance metric[3050]. Of these embodiments, almost all will attempt to factor in obvious real-world reasons for specific fall offs, so that they do not distort the metric.

Such real-world reasons may include but are not limited to: significant distractions related to the emergency at hand, the need to move away quickly from a given area, and the need to engage with other people in some way, such as offering assistance. Most embodiments will assess such things either or both a) in comparison to other incidents[570] of the same category/ies[3030] and / or b) comparing users[1000] — and other sensors[100] — concurrently in the same emergency[505] taking place. Note that there may be more than one category since it is possible that more than one category actually may apply - and reasonably likely that, at least initially, multiple categories[3030] can all appear to offer valid candidate explanations for the incident[570.

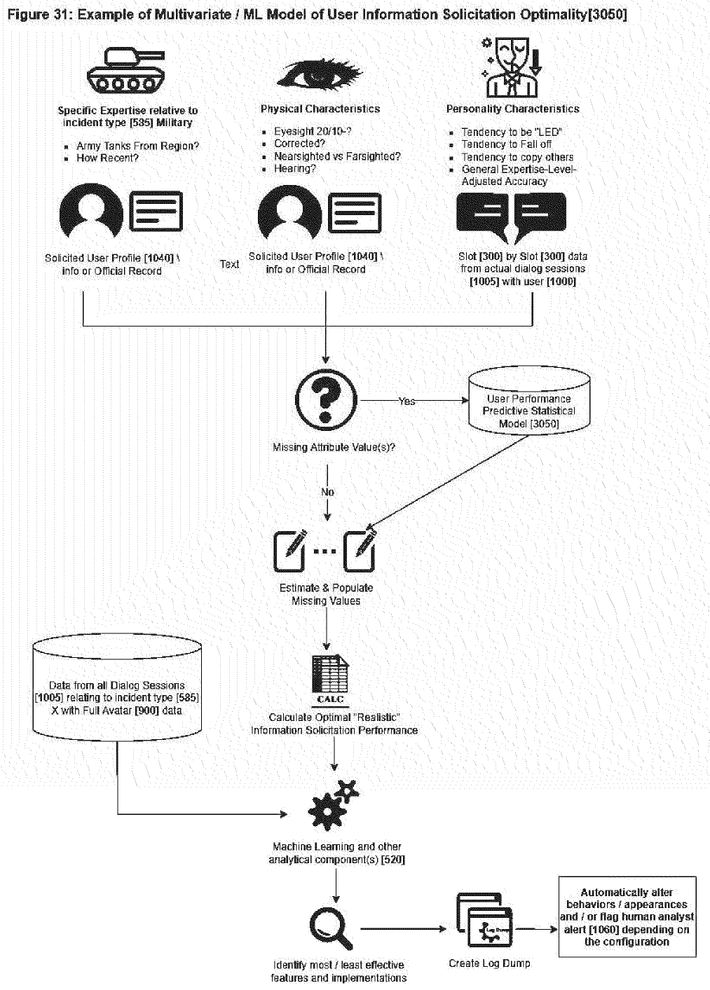

FIG. 31 indicates that in most embodiments, the three buckets of data[2000] will be used to provide training or equivalent data[2000]. These are as follows:

Expertise / knowledge information[985], either/both from the user profile[1040] data in the system[10] and/or any reliable form of record to which the system[10] has access. This data[2000] is critical to be able to assess what kinds and degrees of information[2000] the user[1000] can be reasonably expected to provide. <INSERT EXPERTISE-RECALL CITATION HERE.> For example, a user[1000] with no prior experience with guns may be very likely to say that virtually any gun is an AK-47 only because these are often featured in Hollywood movies. Most embodiments will choose to have fairly extensive hierarchies of expertise[985], since a high level expertise[985] like military has many variations: an infantry soldier may know little to nothing about naval vessels for example; veterans may have knowledge[985] that has grown out of date.

Physical sensing attributes: Some users[1000] will have extraordinarily good — or extraordinarily bad —eyesight or hearing. Limitations[6020] in sight or hearing can be corrected with glasses, hearing aids, and other such implements. Even great eyesight can be further augmented with binoculars or similar; most embodiments will ask not only about any limitations[6020] — or special abilities — of the human as a sensor[1000] but also of any equipment that they have with them. This is necessary because almost embodiments will ask users[1000] for the approximate distance they were from the incident[570].

Data from any dialog sessions[1005] from the user[1000], including the one currently in progress. This includes derived attributes, including but not limited to:
Tendency to be “led” by avatar[902] questions[1170] that are subsequently invalidated based on subsequent event updates[3015] - that is, to provide inaccurate information based on a premise later determined to be false;
Tendency to get frustrated and/or abandon a dialog session[1005] in progress;
Tendency to copy content that they see online without attributing it, for example repeating an online post[510] that sounded authoritative;
Expertise[985]-adjusted accuracy level[6018]; many embodiments will consider accuracy as being bounded by expertise[985] and will make adjustments or qualifications in scoring user[1000] accuracy level[6017] as a result. This is because while specific expertise[985] is very helpful -or even as a practical matter required in order to provide certain types of detailed information
   for other things it may have minimal to no impact. And of course no system can query users[1000] for every type of knowledge[985] that could in some circumstance prove important. For example, if there were an incident[570] in which it would be useful to correctly identify a breed or other characteristics of dog, the system[10] would likely have to fall back to assessing specificity, as described in U.S. Pat. Application 16/576736.

In the event that any of the desired information[2000] is missing - for example, perhaps a user[1000] never answered questions[1170] relating to their eyesight- most embodiments will endeavor to guess based on local population data[2000] regarding visual acuity, coupled with any demographic information[2030] about the user[1000] that is available, for example age. If relevant expertise information[985] is missing, the user’s[1000] content from both prior and current dialog sessions[1005] will be clustered or otherwise statistically matched to that of users[1000] for whom the expertise data[985] is available.

On this basis, one or more analytic components[520] — in many embodiments machine learning —can determine the optimal information[2000] that could have reasonably been extracted from users[1000] by the avatar[902]. This will in general be significantly less than all users[1000] providing accurate, detailed information[2000] (except perhaps in the edge case scenario in which the incident[570] occurred on or near a military installation or similar. For example, an elderly population in a village cannot be expected to provide accurate information[2000] on the type of artillery used in the distance. No improved technology will change this basic fact. It must therefore be accounted for so that the system[10] has accurate information[2000] about where it can realistically improve performance with the human element.

We refer to the output of the one or more analytical components[520] tasked with assessing the effectiveness of different feature[522] sets as the user information solicitation model[6025]. In most embodiments this will include a log and a variety of human analyst-readable performance statistics. Depending upon the particular embodiment, system configuration[125], and the degree to which performance is lagging in some combinations of user[1000] demographic and incident[570] type, either/both a human operator alert[1060] will be generated and/or configuration (static or de facto, depending upon the embodiment) will be made automatically. Most embodiments will not opt to require operator[1050] permission to make routine small adjustments because it would prove a bottleneck. However, especially in the case of anomalies, such as an avatar character[[905] that had been very high performing with a given population of users[1000] suddenly delivering poor results.

Other embodiments may require human operator[1050] approval of changes only for certain types of incidents[570].

Because there will presumably be a large number of dialog sessions[1005] in real world use during incidents[570], as shown in FIG. 26A, there will be numerous features[522] that will vary with user[1000] and context that in most cases can be further optimized. These include, but are not limited to: avatar character[905], context-specific props and attire used by the avatar[900], mapping of avatar[900] emotions to that of the user’s[1000] and/or incident[570] type, the partitioning of mascots[900] into territories[1300], partitioning of the dialog system [1165], and a range of system configuration parameters[125].

Almost all embodiments will log the results to an audit file; depending on the embodiment, some or all of any optimizations may be made automatically or with human analyst[1050] permission. Many embodiments may perform continuous updating[1105] of this information[2000], including adjusting previously assessed accuracy rates[6017] in the event that a very late-arriving potentially invalidating important update event[3017] is received about a particular incident[570]. Most embodiments will include parameters that specify lookback periods for different classes of incidents[570], along with the means of computing them, as well as a generic “unknown” category.

Efficiency: Most embodiments will use one or both of a) number of conversational rounds[1150] and b) elapsed clock time from start to finish of initial dialog session[1005] as measures of efficiency. In the latter case, most embodiments will exclude any pause between rounds[1150] of greater than X minutes from elapsed clock time measure, where X is a configuration parameter[125]. Many embodiments will choose to consider only the number of turns[1150] or minutes it took to extract accurate or meaningful information[2000] - that is, the substantive portion[5025] - rather than the full course of the dialog[1005]. Doing so excludes a variety of things including, but not limited to: exchanging of pleasantries, confirmation requests, repetition of previously provided information[2000], users[1000] expressing fear or other statements with no material data[2000], and informing the user[1000] of updates to the situation as a courtesy (rather than to solicit further data[2000] from them).

Almost all embodiments will factor observed efficiency using their own preferred metrics into its overall performance metrics. Many embodiments will assume that lower efficiency observed in a given constellation of features[522] caused the loss of some amount of otherwise obtainable information from users[1000] who fell out of the dialog tree[1115] because it was taking too long, whether because of boredom, distraction, frustration or simply needing to change locations quickly.

### Assessing User [1000] Accuracy & Trustworthiness [6015] Over Time

Most embodiments will keep a log of users[1000] who have contacted the mascots[900] through any of the available mechanisms, and assess their credibility[6015] over time in the event of repeated contact. Some embodiments may opt to score variables other than credibility, for example sophistication level[6010] with respect to different domains of interest. Each user[1000] will have a stored user profile[1040] with as much data as the system[1010] has been able to collect about them. What exact data[2000] is stored will vary by embodiment, however, standard data[2000] includes, but is not limited to:
Contact information of different kinds;
Membership in any relevant organization (e.g. civic volunteers, law enforcement);
History of prior incident[570] reports;
Scores for credibility or other derived attributes;
Any information that was solicited about eyesight or other attributes that could impact the physical reliability[6020] of the sensor[1000];

For example, in almost all embodiments, users[1000] who contact a mascot[900] frequently and absent any confirmed incident[570] or presence of objects of interest[220] will either no longer have their information[2000] reported back to the system altogether, or if they do will label it as essentially junk. Likewise for users[1000] who, for whatever their reasons may be, appear to be lying based on data[2000] that is exogenous to the dialog[1005]. This can include, but is not limited to, lying about their location[400] based on GPS or other reliable information[2000], who appear to be colluding or acting in concert with other users[1000] or organizations, or who copy content from other users[1000] or sources. Most embodiments will consider repeated apparent lying over time as increased evidence that the user[1000] in question is not a reliable sensor[1000].

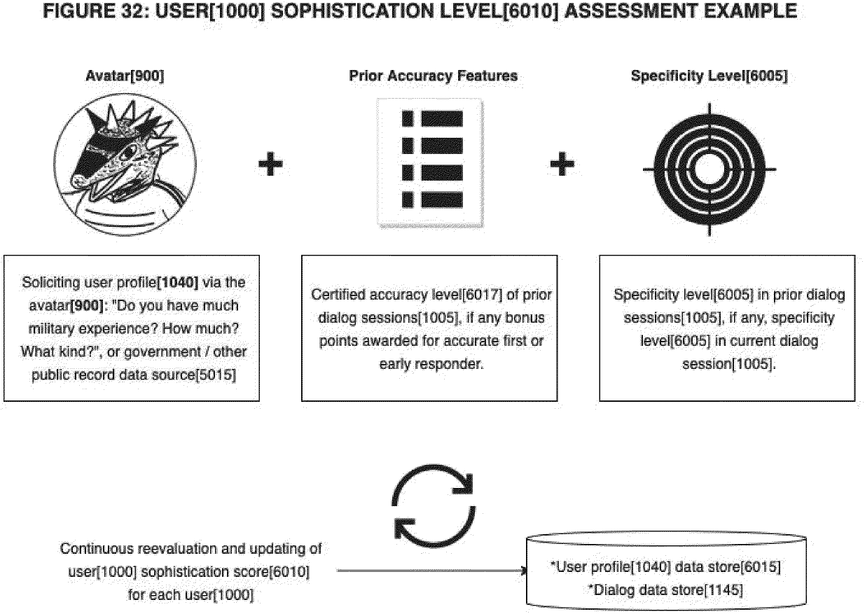

As indicated in FIG. 32, a default embodiment will assess user[1000] sophistication level[6010] according to a combination of user expertise[985], measured accuracy historically with the system[1010] - as noted elsewhere, different embodiments may componentize the notion of accuracy differently (tendency towards being led, copying from others, expertise[985], specificity level[6005], etc.). and Some embodiments may use different measurements or weighting by incident type[585] or region[400]. Many embodiments will choose to augment the sophistication score[6010] in cases in the user[1000] was either the first user[1000] to accurately report data[2000] from an incident[570], or within a brief, system-determined window[3000] from the time that the incident[570] was initiated. This is because rapid reporting greatly decreases the chances that information[2000] is being copied, and because accurate information[2000] delivered amidst initial chaos suggests a higher user[1000] sophistication level[6010].

Embodiments that calculate trustworthiness[6015] or credibility separately will generally discard the expertise[985] portion, apart from potentially providing an accuracy boost for users[1000] who have provided accurate information[2000] without having the relevant expertise[985] established.

Most embodiments will continuously perform calculations of sophistication level[6010], trustworthiness[6015], accuracy level[6017], expertise[985], and other related metrics. For clarity, by “continuously,” in this instance we mean:
1. After the user[1000] completion of, or exit from, each dialog branch[1120], if not in some embodiments after each turn[1150]. Each new user response[3055] provides additional opportunity for assessment; some embodiments will also scan the internet looking for posts by the user[1000] if it has the needed user handle information. Of such embodiments, many will likewise recalculate after each new user[1000] post that is discovered online.
2. After any initial update events[3015] issued from an authoritative source[5015] that either invalidate (partially or fully) information that had been provided by the particular user[1000] or which confirm such information. Some embodiments may prefer to have a lower bar, for example accepting partially-authoritative sources[5015]. This can occur during or after a dialog session[1005] with the user[1000].

The motivation for continuous updating is that in a very highly dynamic environment, things can change very significantly and suddenly. For example, in a war or similar situation, human sensors[1000] and their devices may be captured by an adversary, and thus their reliability will not be at all what it was, or, a “normal” person who last week knew nothing about tanks can now recognize many of their features because they have seen them in their village.

To summarize, areas of improvement over existing approaches include:
1. Rather than simply assembling and analyzing data[2000] as provided by the available sensors [100], a key element of this system[10] is that one sensor [100] can request that another sensor [100] with the capability to supply relevant information[2000] move, perform queries, attempt to solicit information[2000] from the public, or otherwise temporarily modify its behavior so as to provide it data of interest[2000] such that this data[2000] is obtained sooner than would otherwise have been the case - or perhaps at all. Otherwise put, a sensor [100] of one type may temporarily “recruit” another sensor [100], which may be of a totally different type, to perform specific tasks on its behalf if it has the permissions needed to do so.
2. The system[10] described in this document is a largely peer-to-peer one in nature, although most embodiments will have components that aggregate[2025] and analyze data[2000] across the set of available sensors [100]. However, synchronous communication of sensors [100] with other components[495] is not required, as it will not always add value and would impose at least some fractional computational cost[560]. For example, a drone[145] could recruit a traffic camera to fill in missing visual data[2010] without requiring that it first be routed to a computational component[520] that mediates among heterogeneous sensors [100]. This enables optimal efficiency in the necessary data[2010] being obtained by the requestor.
3. The use of social media is not only to passively filter content in pursuit of relevant information[2000], but is also as a medium that avatars[905] can use to actively and directly solicit information[2000] from the public. Such solicitations[555] can be geofenced, community-limited, or directed at individual persons or persons with desired specific attributes, for example requests[3035] for clarification about a given post[510].
4. A dialog system[1010] designed to make dynamic changes[1105] in the dialog[1005] based on breaking events[505].

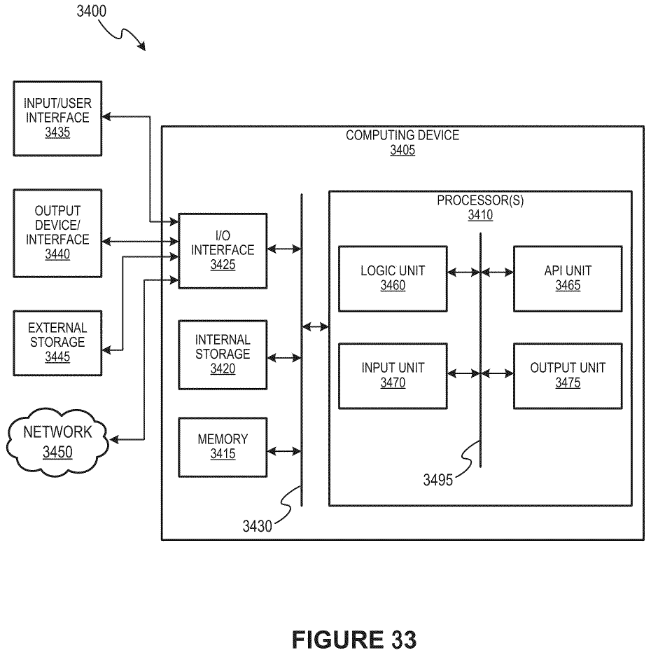

FIG. 33 illustrates an example computing environment with an example computer device suitable for use in some example implementations, such as a server, drone, controller, or other device described herein. Computer device 3305 in computing environment 3300 can include one or more processing units, cores, or processors 3310, memory 3315 (e.g., RAM, ROM, and/or the like), internal storage 3320 (e.g., magnetic, optical, solid state storage, and/or organic), and/or I/O interface 3325, any of which can be coupled on a communication mechanism or bus 3330 for communicating information or embedded in the computer device 3305. I/O interface 3325 is also configured to receive images from cameras or provide images to projectors or displays, depending on the de-sired implementation.

Computer device 3305 can be communicatively coupled to in-put/user interface 3335 and output device/interface 3340. Either one or both of input/user interface 3335 and output device/interface 3340 can be a wired or wireless interface and can be detachable. Input/user interface 3335 may include any device, component, sensor, or interface, physical or virtual, that can be used to provide input (e.g., buttons, touchscreen interface, keyboard, a point-ing/cursor control, microphone, camera, braille, motion sensor, optical reader, and/or the like). Output device/interface 3340 may include a display, television, monitor, printer, speaker, braille, or the like. In some example implementations, input/user interface 3335 and output device/interface 3340 can be embedded with or physically coupled to the computer device 3305. In other example implementations, other computer devices may function as or provide the functions of input/user interface 3335 and output device/interface 3340 for a computer device 3305.

Examples of computer device 3305 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 3305 can be communicatively coupled (e.g., via I/O interface 3325) to external storage 3345 and network 3350 for communicating with any number of networked components, devices, and systems, including one or more computer devices of the same or different configuration. Computer device 3305 or any connected computer device can be functioning as, providing services of, or referred to as a server, client, thin server, general ma-chine, special-purpose machine, or another label.

I/O interface 3325 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 3300. Network 3350 can be any network or combination of networks (e.g., the Internet, local area network, wide area network, a telephonic network, a cellular network, satellite net-work, and the like).

Computer device 3305 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 3305 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 3310 can execute under any operating system (OS) (not shown), in a native or virtual environment. One or more applications can be deployed that include logic unit 3360, application programming interface (API) unit 3365, input unit 3370, output unit 3375, and inter-unit communication mechanism 3395 for the different units to communicate with each other, with the OS, and with other applications (not shown). The described units and elements can be varied in design, function, configuration, or implementation and are not limited to the descriptions pro-vided. Processor(s) 3310 can be in the form of hardware processors such as central processing units (CPUs) or in a combination of hardware and software units.

In some example implementations, when information or an execution instruction is received by API unit 3365, it may be communicated to one or more other units (e.g., logic unit 3360, input unit 3370, output unit 3375). In some instances, logic unit 3360 may be configured to control the information flow among the units and direct the services provided by API unit 3365, input unit 3370, output unit 3375, in some example implementations described above. For example, the flow of one or more processes or implementations may be con-trolled by logic unit 3360 alone or in conjunction with API unit 3365. The input unit 3370 may be configured to obtain input for the calculations described in the example implementations, and the output unit 3375 may be configured to pro-vide output based on the calculations described in example implementations.

Processor(s) 3310 can be configured to control the air compressors remotely through communication of instructions to a corresponding on-board computer of an air compressor. Such instructions can include, but are not limited to, power down, power up, engaging a maintenance mode, and so on in accordance with a desired implementation.

While the invention is susceptible to various modifications and alternative forms, specific embodiments thereof have been shown by way of ex-ample in the drawings and are herein described in detail. It should be under-stood, however, that the description herein of specific embodiments is not in-tended to limit the invention to the particular forms disclosed.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is ap-preciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer sys-tem’s registers and memories into other data similarly represented as physical quantities within the computer system’s memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable sig-nal medium. A computer-readable storage medium may involve tangible mediums such as, but not limited to optical disks, magnetic disks, read-only memories, random access memo-ries, solid state devices and drives, or any other types of tangible or non-transitory media suitable for storing electronic information. A computer readable signal medium may include mediums such as carrier waves. The algorithms and displays presented herein are not inher-ently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more spe-cialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

The foregoing detailed description has set forth various example implementations of the devices and/or processes via the use of diagrams, schematics, and examples. Insofar as such diagrams, schematics, and examples contain one or more functions and/or operations, each function and/or operation within such diagrams, or examples can be implemented, individually and/or collectively, by a wide range of structures. While certain example implementations have been described, these implementations have been presented by way of example only and are not intended to limit the scope of the protection. Indeed, the novel methods and apparatuses described herein may be embodied in a variety of other forms. Furthermore, various omissions, substitutions and changes in the form of the devices and systems described herein may be made without departing from the spirit of the protection. The accompanying claims and their equivalents are intended to cover such forms or modifications as would fall within the scope and spirit of the protection.

1. A method for a sensor system comprising one or more sensors, the method comprising:
monitoring an area with the one or more sensors to obtain first sensor data;
for processing a sensor event to provide second sensor data outside a functionality of the one or more sensors:
identifying another sensor system monitoring the area having the functionality to provide the requested second sensor data, the another sensor system monitoring the area comprising one or more another sensors;
transmitting instructions to the another sensor system to provide the requested second sensor data; and
responding to the sensor event with the requested second sensor data received from the another sensor system.

2. The method of claim 1, further comprising:
monitoring third data from an event feed to detect the sensor event, the event feed providing data from one or more users; and
determining updates for one or more slots associated with one or more object instances of the area based on at least one or more of the first sensor data,
provided second sensor data, or the third data, each of the one or more slots associated with one more object instances observed in the area.

3. The method of claim 2, wherein the identifying the another system is derived from the third data.

4. The method of claim 2, wherein the determining the updates for the one or more slots associated with one or more object instances of the area based on at least one or more of the first sensor data, provided second sensor data, or the third data, comprises:
processing at least one of the first sensor data or the provided second sensor data to verify the third data; and
executing a dialog branch from a dialog tree to a user of the one or more users associated with the third data, the dialog branch configured to provide questions to the user to solicit additional information.

5. The method of claim 4, wherein for the processing of the at least one of the first sensor data or the provided second sensor data indicating that the third data is incorrect, invalidating responses to the questions associated with the third data; and
changing the dialog branch to another dialog branch in the dialog tree configured to provide questions to the user regarding source of the third data.

6. The method of claim 5, wherein the executing the dialog branch from the dialog tree to the user of the one or more users associated with the third data is based on a user information solicitation model configured to determine accuracy statistics of historical data submissions from the user; the dialog brach selected based on maximizing the accuracy statistics for the user.

7. The method of claim 5, further comprising determining the user of the one or more users to be deceptive based one or more of similarity to other deceptive sources, details provided in the third data, or timestamp of the third data; wherein the dialog branch is changed to a deception branch based on the determination.

8. The method of claim 4, further comprising updating the dialog tree based on the at least one or more of the first sensor data, provided second sensor data, or the third data.

9. The method of claim 4, further comprising updating positions of users in the dialog tree based on at least one or more of the first sensor data, the provided second sensor data, or the third data.

10. The method of claim 4, wherein the dialog branch is configured to provide questions to the user through an avatar, wherein optimizations are made to one or more of an attire, emotion, or props of the avatar based on the third data.

11. The method of claim 10, further comprising executing a machine learning algorithm configured to extract user behavior attributes based on audio and visual data of the user, wherein avatar response and emotional state is modified based on the extracted user behavior attributes.

12. The method of claim 10, wherein the avatar is configured to change emotional state and response based on updates to the first sensor data, the provided second sensor data, or the third data.

13. The method of claim 1, further comprising, for processing another instructions received from the another sensor system to provide the first sensor data to the another sensor system, transmitting the first sensor data to the another sensor system.

14. The method of claim 13, wherein the another instructions are associated with an object of interest to be monitored in the area; wherein the method further comprises controlling the sensor system to obtain the first sensor data for the object of interest in the area with the one or more sensors.

15. The method of claim 1, wherein the sensor system is a drone; and wherein the another sensor system is not a drone.

16. The method of claim 1, where the sensor event is associated with an object of interest to be monitored in the area;
wherein the instructions comprises instructions to track the object of interest in the area.

17. A method to facilitate improved measures of agreement between sensors in a system of multiple sensors, the method comprising:
constructing an itemset lattice, each itemset in the itemset lattice comprising a set of sensors from the system of multiple sensors and a fence comprising a plurality of features grouped together according to an objective function within conjoined fields of view across the set of sensors; and
measuring sensor consistency based on the fences in the itemset lattices when the system of multiple sensors is enabled; and
detecting anomalies based on the sensor consistency.

18. The method of claim 17 wherein the measuring sensor consistency based on the fences in the itemset lattices when the system of multiple sensors is enabled comprises utilizing fences derived from different, successive time slices sensor consistency comparison; and
wherein the method further comprises identifying additional measures of sensor consistency.

19. The method of claim 17, further comprising:
selecting possible fences in successive timeslices;
measuring the sensor consistency between the selected possible fences and itemsets associated with corresponding prior fences.

20. The method of claim 17, wherein the measuring the sensor consistency is conducted on a stream of sensor data associated with the fences in real time;
wherein the detecting the anomalies based on the sensor consistency is conducted in real time.

21. A method for managing user information provided to a sensor system associated with an event, the method comprising:
responsive to receipt of the user information directed to the event, the user information directed to a slot from a plurality of slots:
executing a dialog branch to solicit information from the user associated with the user information;
controlling one or more sensors associated with the slot from the plurality of slots to measure sensor data associated with the slot;
and for receipt of sensor data for updating the slot, updating the dialog branch based on the received sensor data.

22. The method of claim 21, wherein the executing the dialog branch to solicit information comprises:
for a determination that the user information is sensitive, transmitting instructions to the user to provide the user information to a secure channel;
wherein the dialog branch is executed within the secure channel.

23. The method of claim 21, wherein the user information directed to the event is received through social media application;
wherein the executing the dialog branch comprises utilizing a mascot to respond to the user through the social media application.

24. The method of claim 23, wherein the mascot is configured to change body language and facial expression based on response to be provided to the user through the dialog branch and one or more inputs received from other users.

25. The method of claim 21, wherein the executing the dialog branch comprises:
for a lexical similarity of the user information received from the user being similar to known adversaries or flagged suspicious users, selecting the dialog branch for untrusted users;
for the user information being similar to sensor or user data flagged to be trusted, selecting the dialog branch directed to trusted users.

26. The method of claim 21, wherein for the sensor data updating the slot differing from the user information, selecting the dialog branch to solicit additional user information from the user.
